(19) United States
(12) Patent Application Publication
(10) Pub. No.: US 2012/0060662 A1
(43) Pub. Date: Mar. 15, 2012

(54) AUTOMATED STICK-FRAME SYSTEM

(75) Inventors: FOSTER D. HINSHAW, Cambridge, MA (US); William J. Fosnight, Saratoga Springs, NY (US)

(73) Assignee: Dummow Systems Corporation, Cambridge, MA (US)

(21) Appl. No.: 13/178,138

(22) Filed: Jul. 7, 2011

Related U.S. Application Data
(60) Provisional application No. 61/362,139, filed on Jul. 7, 2010.

(51) Int. Cl. B27B 5/29

(52) U.S. Cl. 83/364

(57) ABSTRACT

A automated stick cutting system is provided adapted to produce stick-frame construction components from material for building construction. The automated stick cutting system has a frame having an in-feed portion and an out-feed portion. A saw is adapted to cut the material, the saw coupled to the frame. An in-feed drive is coupled to the frame, the in-feed drive adapted to accept the material from the in-feed portion and feed the material to the saw. A position detector is coupled to the frame, the position detector adapted to track a position of the material relative to the in-feed drive. An out-feed drive is adapted to accept the material uncut from the in-feed drive, the out-feed drive adapted to accept the material cut from the saw and feed cut material to the out-feed portion. An edge detector is adapted to detect a leading edge of the material when being fed to the saw by the in-feed drive. The position detector and the edge detector cooperate with operation of the saw to meter lengths of the material through the in-feed drive and to cut a predetermined length of the material with the saw.

### RELATED APPLICATIONS

This application claims priority from U.S. Provisional Patent Application Ser. No. 61/362,139 Filed Jul. 7, 2010 entitled “AUTOMATED STICK-FRAME SYSTEM” which is hereby incorporated by reference herein in its entirety.

### BACKGROUND

1. Field

The disclosed embodiments relate to an automated stick system and, more particularly, to an automated machine adapted to produce stick-frame construction components.

2. Brief Description of Earlier Developments

Home construction projects often may involve many different forms of carpentry, from framing carpentry through finish carpentry. Typical construction involves a general contractor hiring carpenters by the job or by the hour to complete framing, trim or finish operations. To complete the job, detailed construction plans are provided to the carpenters from which the carpenter provides lumber, for example, framing lumber, finish mill work or other lumber suitable for the type of construction, fasteners, labor and equipment to complete the project. In a framing instance, typically pieces of lumber that make up a wall, floor or otherwise are cut to size by individual measurement or by using jigs and templates and subsequently assembled into a portion of the framing and integrated on site. In a finish carpentry instance, typically pieces of lumber that make up finish trim are cut to size by individual measurement and hand fit for a finished product. A problem arises in using traditional construction techniques as the process can be time consuming and costly due to the high level of manual labor involved in fabricating the lumber to size and the large amount of scrap incurred in the construction process. Accordingly, there is a desire to reduce the amount of time, labor and scrap associated with the construction process.

### BRIEF DESCRIPTION OF THE DRAWINGS

The foregoing aspects and other features of the exemplary embodiments are explained in the following description, taken in connection with the accompanying drawings, wherein:

FIG. 1 is a isometric view of an automated stick system;

FIG. 2 is a isometric view of an automated stick system;

FIG. 3 is a top view of an automated stick system;

FIG. 4 is a front view of an automated stick system;

FIG. 5 is a side view of an automated stick system;

FIG. 6A is a isometric view of a chop saw;

FIG. 6B is a isometric view of a chop saw;

FIG. 7A is a top view of a chop saw;

FIG. 7B is a front view of a chop saw;

FIG. 7C is a side view of a chop saw;

FIG. 8 is a side view of a chop saw;

FIG. 9A is a front isometric view of a clamp;

FIG. 9B is a rear isometric view of a clamp;

FIG. 10A is a top view of a clamp;

FIG. 10B is a side view of a clamp;

FIG. 10C is a front view of a clamp;

FIG. 11 is a front view of an automated stick system;

FIG. 12 is a isometric view of an automated stick system;

FIG. 13 is a block diagram of an automated stick system;

FIG. 14 is a flow diagram of an automated stick system;

FIG. 15 is a flow diagram of an automated stick system;

FIG. 16 is a isometric view of an automated stick system;

FIG. 17 is a top view of an automated stick system;

FIG. 18 is a front view of an automated stick system;

FIG. 19 is a side view of an automated stick system;

FIG. 20 is an isometric view of a drill;

FIG. 21 is an isometric view of a drill;

FIG. 22 is a top view of a drill;

FIG. 23 is a side view of a drill;

FIG. 24 is a front view of a drill;

FIG. 25 is a top view of a panel table;

FIG. 26A is a top view of a portable stick cutting system; and

FIG. 26B is a top view of a portable stick cutting system.

### DETAILED DESCRIPTION OF THE EXEMPLARY EMBODIMENT(S)

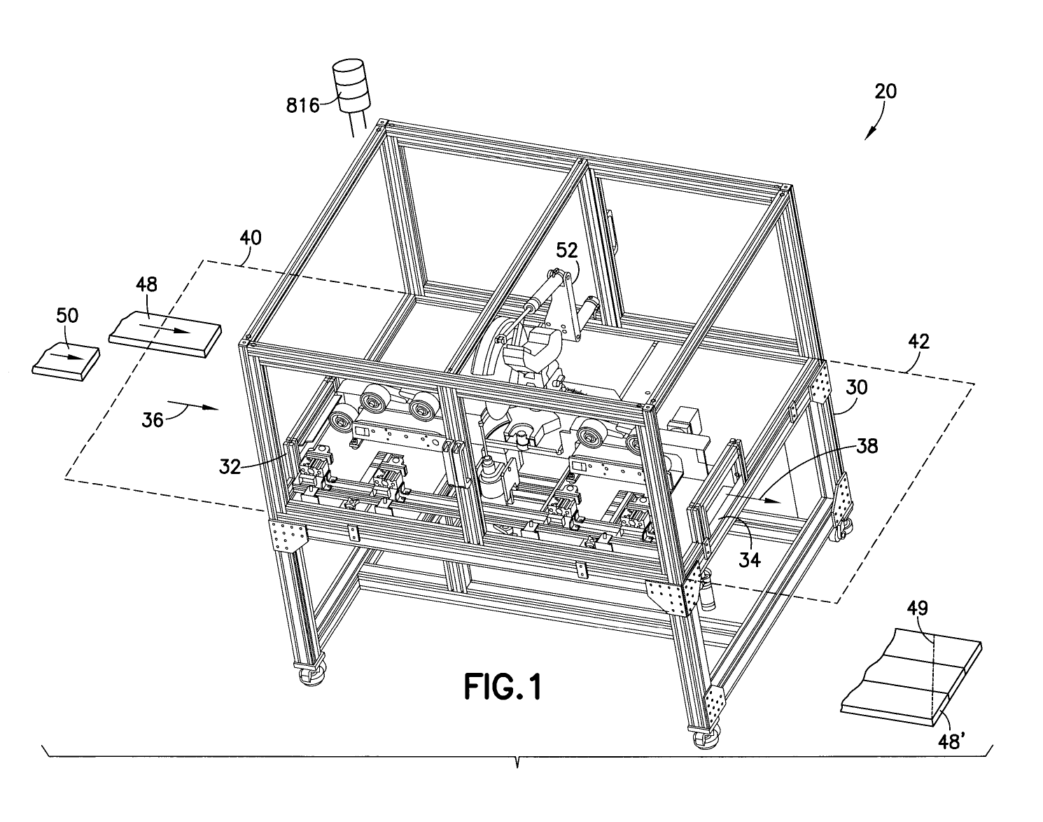

Referring to FIG. 1, there is shown, an isometric view of an automated stick system 20 capable of cutting framing or trim components or otherwise for use in construction or otherwise incorporating features in accordance with an exemplary embodiment. Although the present invention will be described with reference to the embodiments shown in the drawings, it should be understood that the present invention can be embodied in many alternate forms of embodiments. In addition, any suitable size, shape or type of elements or materials could be used.

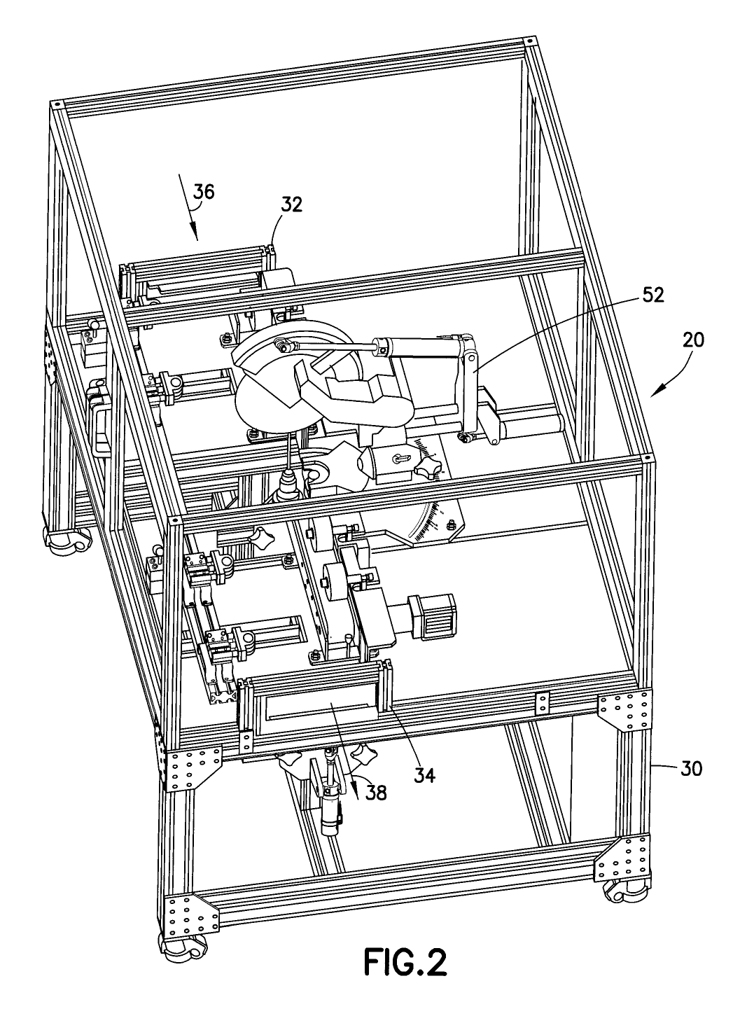

Referring also to FIG. 2 there is shown an isometric view of an automated stick-frame system 20. In the embodiment shown, stick machine or system 20 may comprise frame 30 having infeed portion 32 and outfeed portion 34. Lumber is fed in a direction 36 through infeed portion 32, the lumber processed and the lumber exits system 20 in direction 38 through outfeed portion 34. An in-feed drive, including for example in-feed conveyor 40, and out-feed drive, including for example out-feed conveyor 42, may be provided to feed and exit lumber from system 20. The feed source may be from any suitable lumber supply, for example, lumber pallets or a lumber supply of various sizes, grades and types of lumber loaded manually or delivered via an automated storage and retrieval system (ASRS—not shown) to keep system 20 utilized. Processed or finished lumber may be sent to pallets manually or via conveyor and an automatic or semi-automatic palletizer. Single pieces of lumber may be processed or sets/kits of lumber may be processed by system 20. For example, a kit for framing a wall, floor or otherwise may be provided and either assembled directly after processing or palletized and sent to the job site for assembly. In an alternate example, one or more rooms of finished trim may be provided. System 20 may be portable, such that it may fit easily within a ½ or ¾ ton pickup truck, van or panel truck. Alternately, the system may be transported by a trailer and mounted there on for portability. As will be described in greater detail below, system 20 may be used stand alone or in conjunction with other automation on or off the job site in a manual, semi-automatic or automatic mode processing individual pieces of lumber or providing kits making up from a portion of a construction project to a full construction project. Stick machine 20 may perform any of a number of operations or processes on one or more pieces of lumber 48, 50. Although lumber 48, 50 are shown, system 20 may be used and applied to any suitable stick or building material in addition to lumber, for example, system 20 may be used in conjunction with plumbing construction components such as pvc or copper piping. By way of further example, system 20 may be used with metal studs, structural members, composite structures, aluminum, plastic or other sheathing, trim, siding, composite decking, or any suitable material that needs to be processed before integration into a construction project. By way of further example, system 20 may be used with electrical components, such as metal or plastic conduit, wire or otherwise. The processes or operations may include cutting, providing identification of the piece on the piece, drilling holes or shapes, for example, for electrical or plumbing, marking the piece, for example for locating adjoining lumber or circuits, electrical boxes or otherwise. In alternate embodiments, more or less processes may be provided, for example, providing location pins in the lumber or providing items mounted to the lumber, such as nailing plates, interconnect boxes, harness(es) or plumbing clamps or otherwise, providing further operations such as bending or forming either cold or hot, milling or otherwise. In alternate embodiments, a vision system or bar code reader may be used for any of a number of purposes, for example identifying position, orientation or size and type of material, such as where a bar code on the material uniquely identifies the material type and size or where a vision system identifies material, orientation, size or any other suitable feature(s). In alternate embodiments, a module may be added which adds an identifying indicia to the material, where the module may be a bar code printer, fiducial stamper or RFID tag applicator or otherwise. As such, system 20 may apply any process to a given piece of material, lumber or stick component that would be applicable to that component through the entire construction process and to any component in the construction process suitable for processing in system 20. By way of example, system 20 may print an ascending series of marks 49 on separate pieces of lumber 48′ that form a kit such that a user may identify that the pieces are in proper order for assembly by visually checking that the marks align properly. By way of further example, system 20 may print a series of marks on individual or separate pieces of lumber 48′ corresponding to a pattern, such as a 16 or 24 inch or otherwise a framing pattern or every inch or every six inches or otherwise such that a user may not need a tape measure or separate plan and may visually checking the marks corresponding to a measurement or board and stud location or other position. System 20 may be used to provide lumber or sequenced kits of lumber with features as needed for use with other material handling equipment as described in U.S. Provisional Patent Application Ser. No. 61,422,501 Filed Dec. 13, 2010 entitled “CONSTRUCTION MATERIAL HANDLING METHOD AND APPARATUS” which is hereby incorporated by reference herein in its entirety. System 20 may be used to provide alignment, assembly or other suitable features as needed and may utilize alignment, pin setting or other suitable devices, all as described in U.S. Provisional Patent Application Ser. No. 61,422,476 Filed Dec. 13, 2010 entitled “FRAME CONSTRUCTION METHOD AND APPARATUS” which is hereby incorporated by reference herein in its entirety. System 20 may have tracking features and may provide material with tracking features and be used to provide alignment, assembly or other suitable features as needed and may utilize alignment, tracking other suitable devices, all as described in U.S. Provisional Patent Application Ser. No. 61,422,508 Filed Dec. 13, 2010 entitled “CONSTRUCTION FASTENING AND LOCATING SYSTEM AND METHOD” which is hereby incorporated by reference herein in its entirety. In the embodiment shown, system 20 is provided with cut off saw 52 which may be without a miter as shown although a saw with a miter may also be provided either actuated as part of saw 52 or as a second, or third saw (not shown). In alternate embodiments, more or less saws may be provided. As such, system 20 provides an automated system or stick machine that produces stick-frame construction components, for example, studs, top plates, bottom plates, joists, rafters, blocking or otherwise from standard or custom dimensional lumber or material. As will be described in greater detail below, system 20 may be programmed directly from the system controller or may receive CAD data translated from a model, for example, a framing model directly or from host communications. Stick machine may cut boards to length, with manually or automatically adjustable miter and bevel, may drill holes for electrical and plumbing, may mark boards, for example, with board identification, stud locations, hole identification electrical circuit or plumbing identification, electrical outlet locations, switch locations, data cables or otherwise. Machine 20 may also drill holes for pinned connections to bottom of panels, top of panels or at stud locations to permit alignment or otherwise as needed. Stick machine 20 may be fed a broad range of material sizes, for example, in the framing instance, system 20 may be fed 2″×3″ through 2″×12″ lumber where system 20 may prompt a user to load appropriate board lengths that minimizes waste of parts to be produced. In alternate embodiments, machine 20 may have a front portion that selects and loads lumber automatic. In alternate embodiments, system 20 may process larger or smaller materials with different shapes or material properties. Machine or system 20 may be portable to a job site or location proximate a home construction project. This portability is different than prior art machines such as Hundegger SC-1, Alpine ALS or Koskovich Omnisaw, all of which are heavy, industrial equipment that are permanently installed making them impractical for use in a portable fashion, portable to a job site or by way of further example, to a temporary mill site.

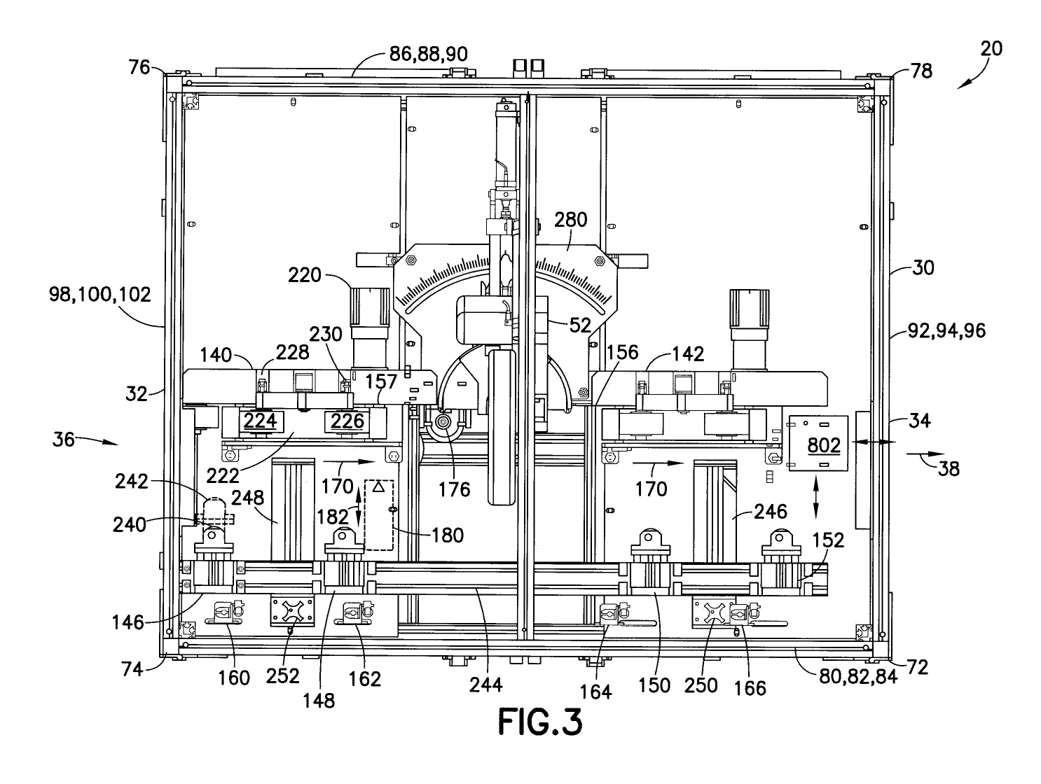

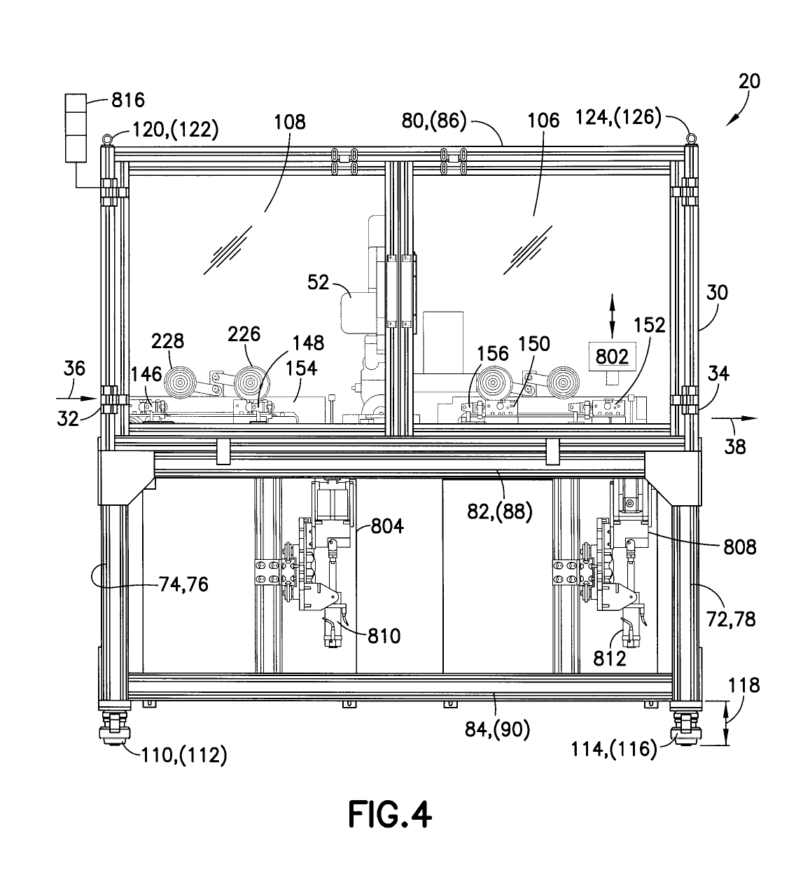

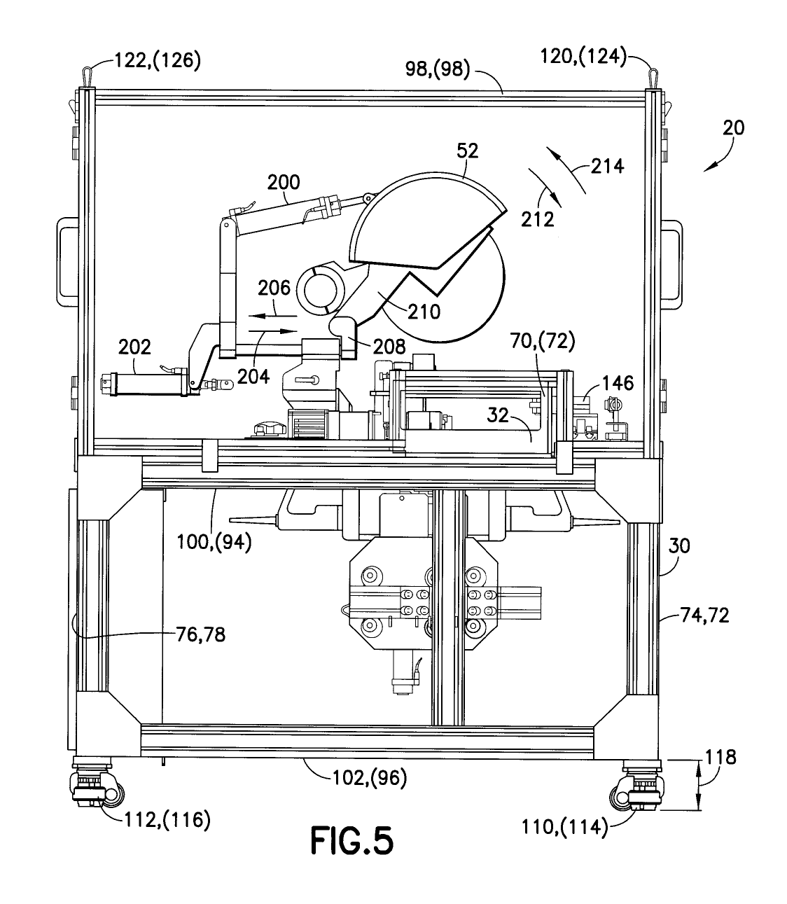

Referring now to FIG. 3, there is shown a top view of automated stick system 20 shown in FIGS. 1 and 2 which will be described in greater detail below. Referring also to FIG. 4, there is shown a front view of automated stick system 20. Referring also to FIG. 5, there is shown a side view of automated stick system 20. In the embodiment shown, stick machine or system 20 may comprise frame 30 having infeed portion 32 and outfeed portion 34. Lumber is fed in a direction 36 through infeed portion 32, the lumber processed and the lumber exits system 20 in direction 38 through outfeed portion 34. Ports 70, 72 are provided respectively on infeed portion 32 and outfeed portion 34 through which lumber or material are fed. Sensors, such as through beam or presence sensors (not shown) may be provided in ports 70, 72 to indicate presence of material to provide for interlocks, for safety or to prevent double loading or otherwise as needed. Frame 30 has vertical members 72, 74, 76, 78, and horizontal members 80, 82, 84, 86, 88, 90, 92, 94, 96, 98, 100, 102. Hinged access panels 106, 108 may be provided of a material suitable to view operation of the tool but of sufficient durability to provide a safety barrier during operation. Hinged access panels 106, 108 may have switches sensing closure of the panels in order to provide for safety interlocks during both operation and service of the system 20. In alternate embodiments, more or less interlocked access panels may be provided. More or less access panels may similarly be applied on all other surfaces of system 20, and may be made of any suitable material, for example, polycarbonate or powder coated steel or otherwise as required to provide safe access for service and/or covers for aesthetic purposes. The interior portion of system 20 may be held with negative pressure within the enclosure to reduce dust and noise. Leveling casters 110, 112, 114, 116 may be provided to allow for manual transportation and leveling. In alternate embodiments, powered leveling and/or transport may be provided as part or separate from system 20. Clearance 118 may be provided under the upper portion of frame 30 in order to facilitate portability and ease of transport, for example by pallet jack, fork or otherwise. Lift points 120, 122, 124, 126 may provided on the top of the upper portion of frame 30 in order to facilitate portability and ease of transport, for example by lift or otherwise. In the embodiment shown, system 20 is provided with cut off saw 52 which may be without a miter as shown although a saw with a miter may also be provided either actuated as part of saw 52 or as a second saw (not shown). A bin or conveyor (not shown) may be located below saw 52 in order to catch or transport scrap material. In the embodiments shown, the table 280 of the saw 52 has been reversed whereby miter graduations can be seen from the rear of saw 52 as opposed to from the front as is typical. As will be described in greater detail below, saw 52 has chop cylinder 200 and slide cylinder 202, both of which may have limit sensors whereby the extremes of motion or selected intermediate points of motion may be monitored and interlocked as appropriate. In the embodiment shown, pneumatic cylinders are used on saw 52 or other drilling or cutting components such that a substantially constant force is applied to the material as opposed to a position control. The use of force control extends the life of blades and bits as the cuts length of time is naturally varied depending on the type and hardness of material being cut. Further, each cylinder may be fit with its own pressure regulator to optimize the force applied. Slide cylinder 202 slides trunnion 208 and motor blade 210 portions in direction 204 when retracted and in direction 206 when extended. Cylinder 200 rotates motor blade 210 portion in direction 212 when extended and direction 214 when retracted.

The in-feed drive section and the out-feed drive section are arranged to feed material through system 20, and are both configured to independently position uncut material with respect to the saw 52 (and other feature forming components) as will be described in greater detail below. Material is fed from input portion 32 to cut off saw 52 along path 170 with clamping and metering conveyor 140 of the infeed drive, where material subsequently is fed from cut off saw 52 to exit portion 34 along path 170 with clamping and metering conveyor 142. As will be described in greater detail below, clamping and metering conveyor 140 has servo drive 220 which drives friction belt 222. Friction belt 222 may reside with a belt surface above the normal path 170, for example, 0.060″ above the plate or path. Belt 222 may have a friction coating, and may for example, be Brecoflex 3″ wide with PVC-Blue backing. Pressure rollers 224, 226 have springs and cylinders which drive the material along path 170 against belt 222 such that the material will not slide with respect to belt 222 when driven. Rollers 224, 226 are driven in the direction of belt 222 by cylinders 228, 230 respectively, both of which may have limit sensors whereby the extremes of motion or selected intermediate points of motion may be monitored and interlocked as appropriate. Different pressures may be applied to cylinders 228, 230 during different operations. For example a lower pressure may be applied when moving material as opposed to when cutting material with saw 52. As seen in FIG. 3, retractable side clamps 146, 148 of the in-feed drive may hold material against guide 157 while retractable side clamps 150, 152 hold material against guide 156 within the out-feed drive. By way of example, slide clamp 146 has roller 240 and extends to position 242 when pressure is applied. Different pressures may be applied to cylinders 146, 148, 150, 152 during different operations. For example a lower pressure may be applied when moving material as opposed to when cutting material with saw 52 or drilling material or otherwise. The lower pressure allows for transport of warped materials and more compliance. Cylinders 146, 148, 150, 152 may have limit sensors whereby the extremes of motion or selected intermediate points of motion may be monitored and interlocked as appropriate In the embodiment shown, cylinders 146, 148, 150, 152 are mounted to bracket 244 which in turn is slidably mounted to rails 246, 248 and manually movable by loosening knobs 250, 252 to accommodate different thickness materials. In alternate embodiments, the stroke of cylinders 146, 148, 150, 152 may be sufficient to accommodate a full range of material thickness. Further, in alternate embodiments, rails 246, 248 may be replaced by actuators capable of moving cylinders 146, 148, 150, 152 such that set up is automatic based on the size of material to be processed. Proximity detectors 160, 162, 164, 166 detect where material is present along four different portions of path 170 through system 20 and provide for interlocking signals to avoid misfeeds, double feeds or otherwise. Edge sensor 176 detects a leading edge of the material being fed along path 170. Alternately, sensor 162 may be utilized as an edge sensor. By coordinating the position feedback capability of metering conveyor 140 with edge detector 176, and utilizing both the position of the cut of chop saw 52 relative to detector 176 and the thickness of cut of chop saw 52, very precise lengths of material may be metered through conveyor 140 and conveyor 142 and cut with chop saw 52. Printer 180 may be provided to print some indicia on the material being transported on path 170. Printer 180 has a vertical printing column and utilizes metering conveyor 140 in conjunction with the vertical printing column to produce two dimensional images on an edge of the material being transported. In alternate embodiments, more than one printer may be provided, for example, to print on different surfaces of the material. Printer 180 may me an ink jet printer, laser printer or any suitable printer. Printer 180 may be mounted on a movable platform, for example allowing printer 180 to be independently positionable, either manually or by control, for example, by servo, stepper or pneumatically, along axis 182. In alternate embodiments, printer 180 may be mounted in a different attitude, for example, printing against the upper or lower horizontal surface(s) of material travelling along path 170. Although system 20 has been described with respect the disclosed embodiments, the disclosure is such that many alternate embodiments may be applied. For example, the internal portion of system 20 may be made modular allowing addition or subtraction of features such as milling, a dado cutter, additional saw(s) with additional manually or automatically adjustable axis, drill(s), any of a number of types of cutters or shapers or otherwise. By way of example, drills 804, 808 may be added with drill bits, forstner bits or otherwise and pneumatically driven by cylinders 810, 812 to make holes or slots within the material being processed. In alternate embodiments, more or less drills on more or less axis of motion may be provided. In addition, features may be added to the feeders or system 20 where the orientation of the fed material may be changed allowing for different cuts or different approaches of the tools and process'. Alternately, additional axis' of motion may be added to the processes whereby the processes may approach the materials, for example, at different angles. By way of example, the printer portion may be placed on a rotary and/or linear automatic or manually actuated axis whereby different surfaces of the material may be printed upon by the same printer. By way of further example, a drill may be mounted on one or more automated linear axis perpendicular to direction 170 where milling operations may be performed allowing for features wider than the bit or deeper or shallower than a nominal depth of the drill/end mill. CNC router 802 may be provided with one or more axis of motion that may be coordinated with drives 140, 142 to provide for holes, slots or for cross cuts of material. Alternately, router 802 may be provided as one or more pin setter(s) where wood, steel or other suitable pins are positioned in any suitable surface of the material being processed for location, for example, with a mating hole on an adjoining piece of material to provide for precise and fast assembly. Here, blind holes and/or pins may be provided as a locating feature for mating material, automation or otherwise. A suitable pin setting or hole/slot feature example is described in U.S. Provisional Patent Application Ser. No. 61,422,476 Filed Dec. 13, 2010 entitled “FRAME CONSTRUCTION METHOD AND APPARATUS” which is hereby incorporated by reference herein in its entirety.

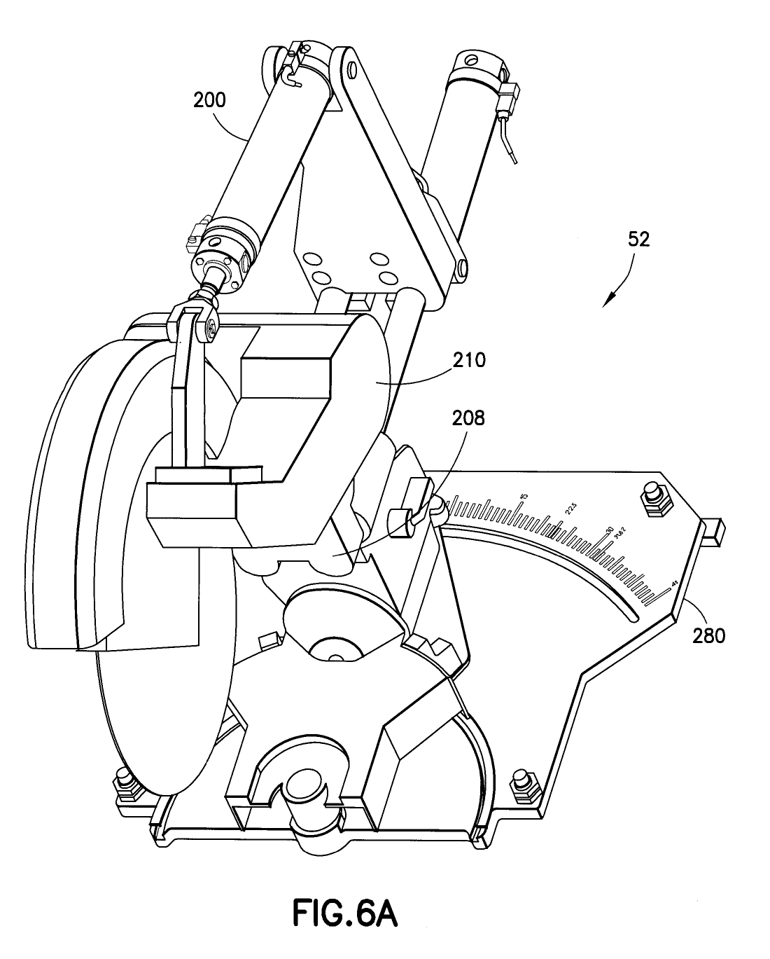

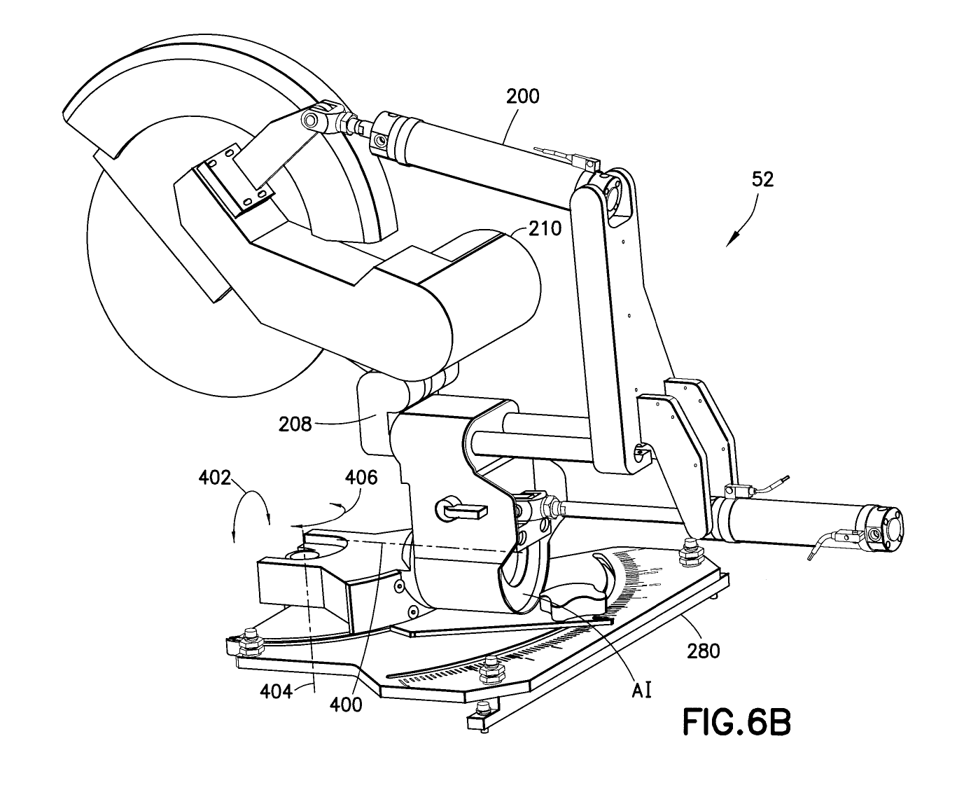

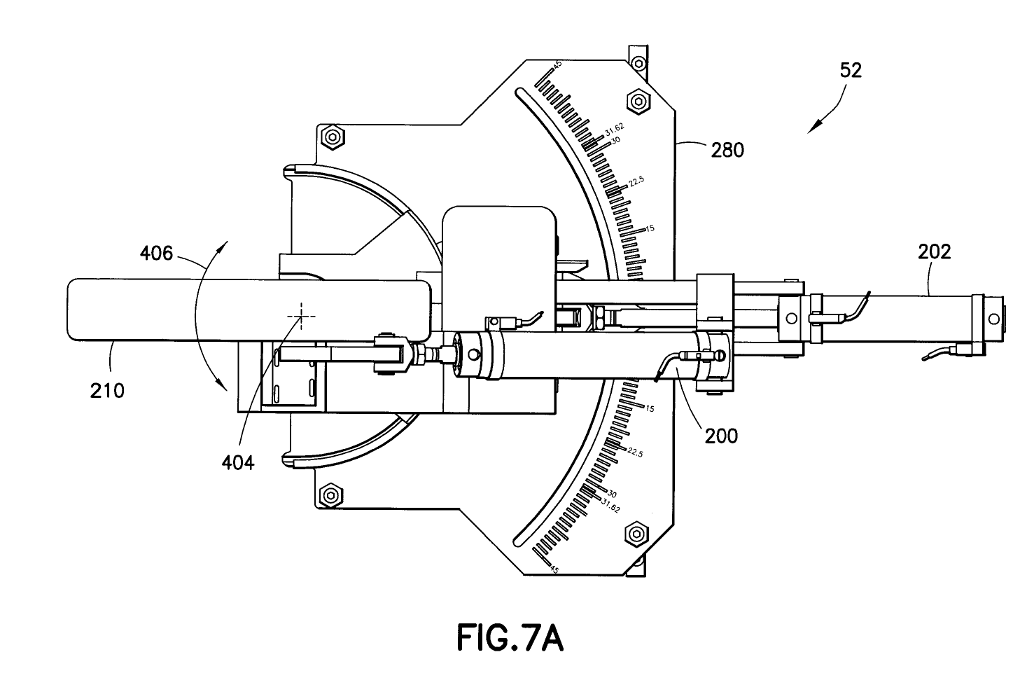

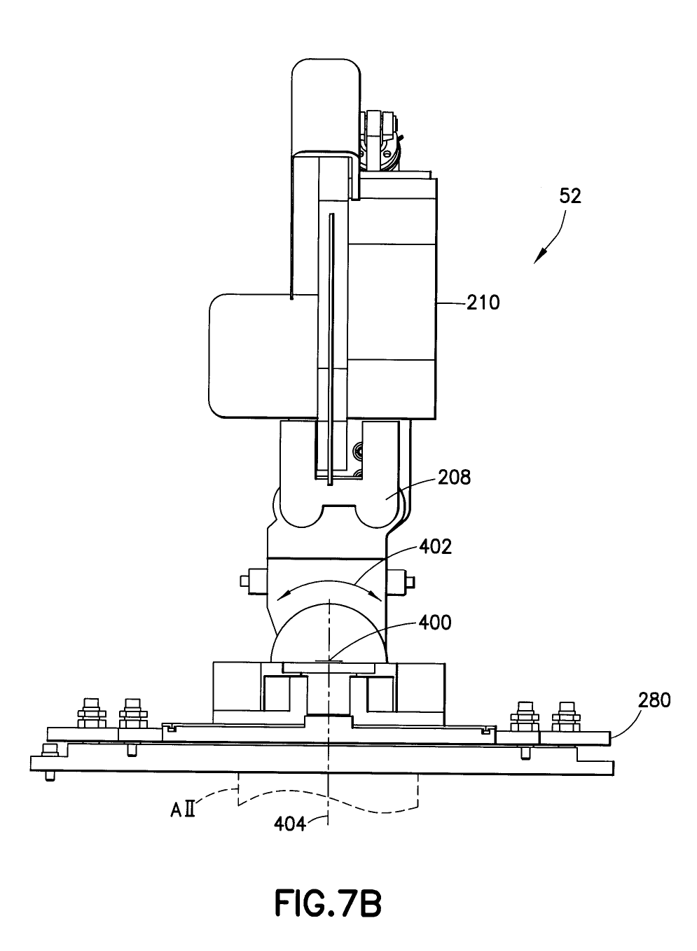

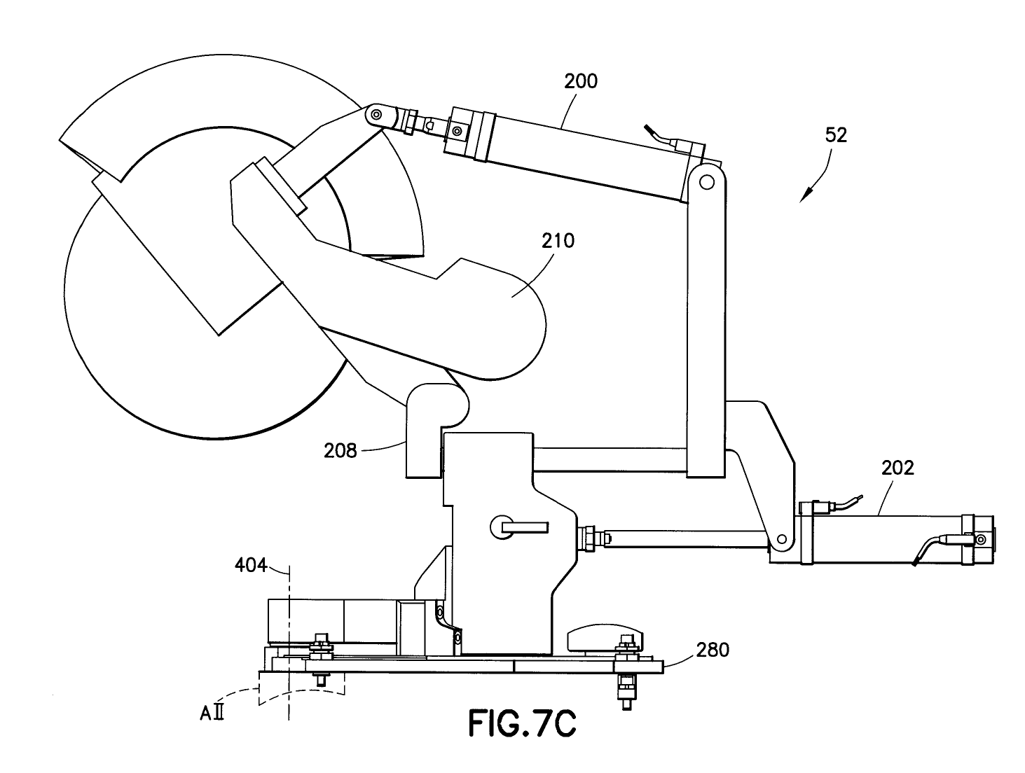

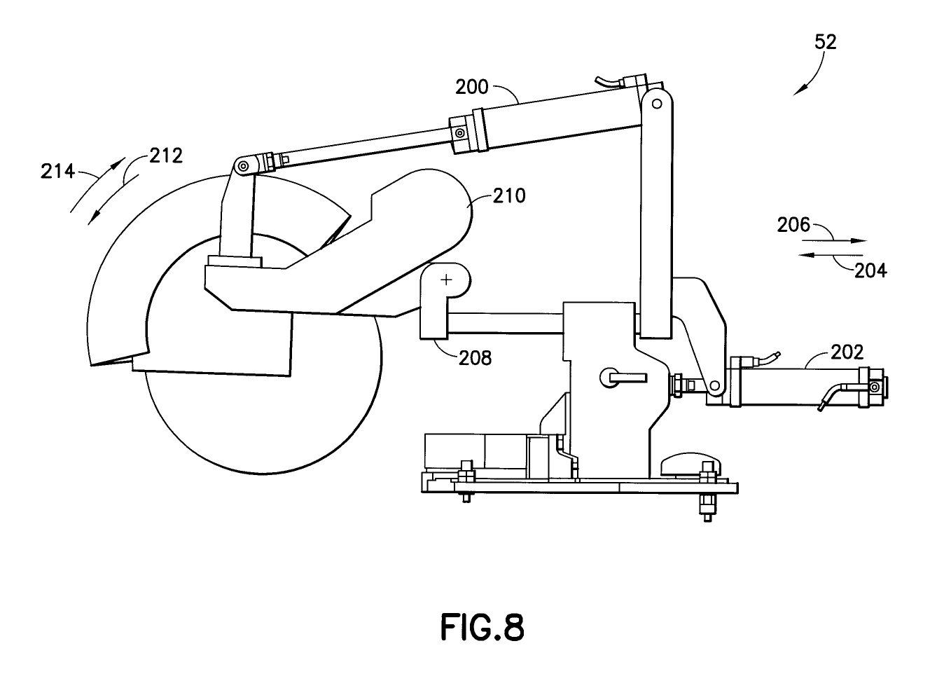

Referring now to FIG. 6A, there is shown a isometric view of a chop saw. Referring also to FIG. 6B, there is shown a isometric view of a chop saw. Referring also to FIG. 7A, there is shown a top view of a chop saw. Referring also to FIG. 7B, there is shown a front view of a chop saw. Referring also to FIG. 7C, there is shown a side view of a chop saw in a raised retracted position. Referring also to FIG. 8, there is shown a side view of a chop saw in a lowered extended position. In the embodiment shown, system 20 is provided with cut off saw which may be with a manual miter as shown. In alternate embodiments additional axis may be provided. For example, axis 400 may be driven by rotary actuator AI where the user may automatically select an angle, for example between 0 degrees (vertical) and +/−45 degrees in direction 402 where actuator AI, for example may be a servo actuator, will automatically drive to the commanded angle. By way of further example, axis 404 may be driven by rotary actuator All where the user may automatically select an angle, for example between 0 degrees (perpendicular to path 170) and +/−45 degrees in direction 406 where actuator AII, for example may be a servo actuator, will automatically drive to the commanded angle. In alternate embodiments, the actuator may be a linear actuator or cylinder with a pivot. In the embodiments shown, the table 280 of the saw 52 has been reversed whereby miter graduations can be seen from the rear of saw 52 as opposed to from the front as is typical. As will be described in greater detail below, saw 52 has chop cylinder 200 and slide cylinder 202, both of which may have limit sensors whereby the extremes of motion or selected intermediate points of motion may be monitored and interlocked as appropriate. In alternate embodiments, cylinders 200, 202 may be replaced, for example, by linear servo driven ball screws, rotary actuators or other suitable actuator. Cylinders 200, 202 each have two air ports that may be plumbed such that the opposite side of the cylinder only exhausts when pressure is applied to the opposing side, for example with piloted check valves. In this manner, when air is dumped, for example with an e-stop event, the check valves close to keep the saw (drill or other component) in position as the opposing ports at the ends of the cylinder are sealed. Slide cylinder 202 slides trunnion 208 and motor blade 210 portions in direction 204 when retracted and in direction 206 when extended. Cylinder 200 rotates motor blade 210 portion in direction 212 when extended and direction 214 when retracted.

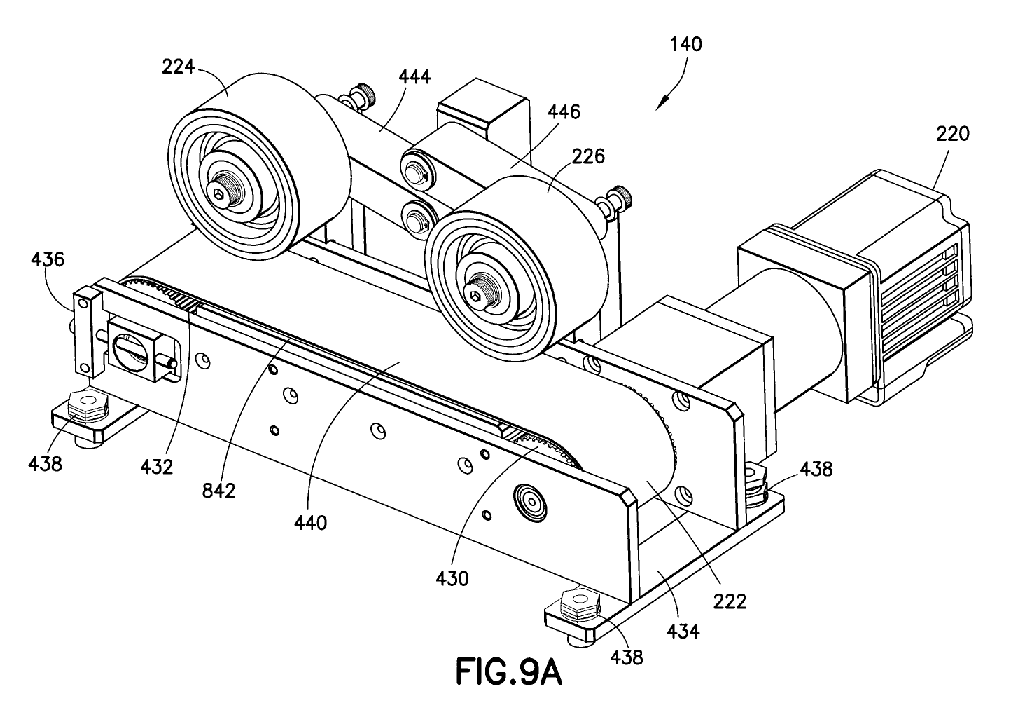

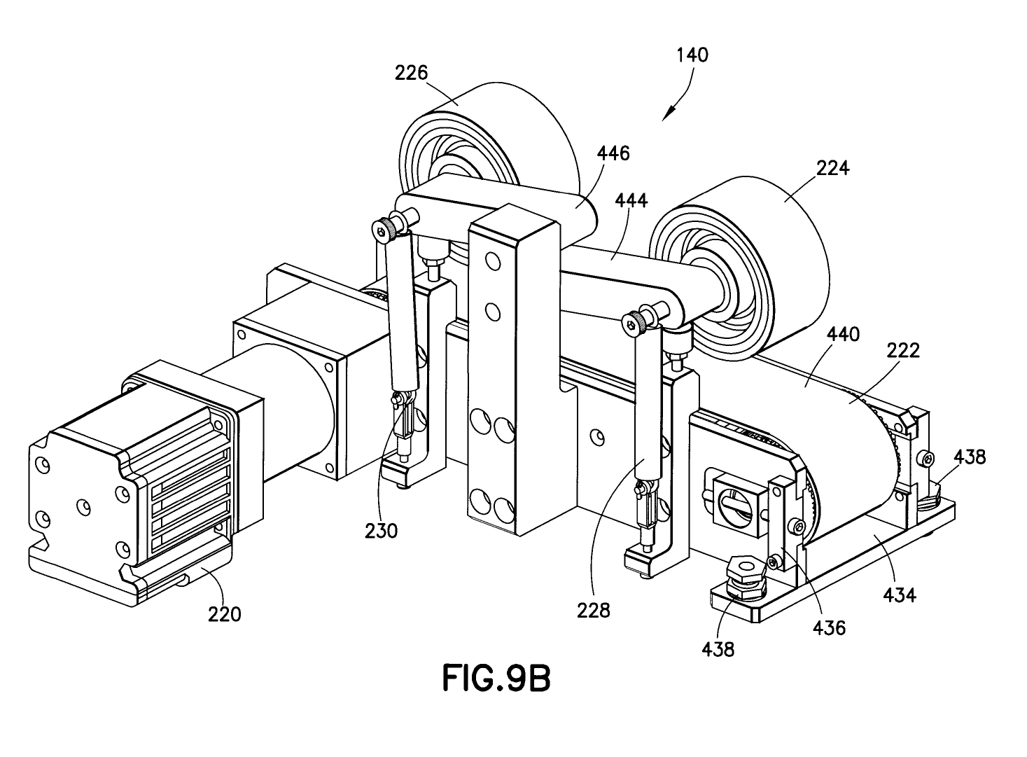

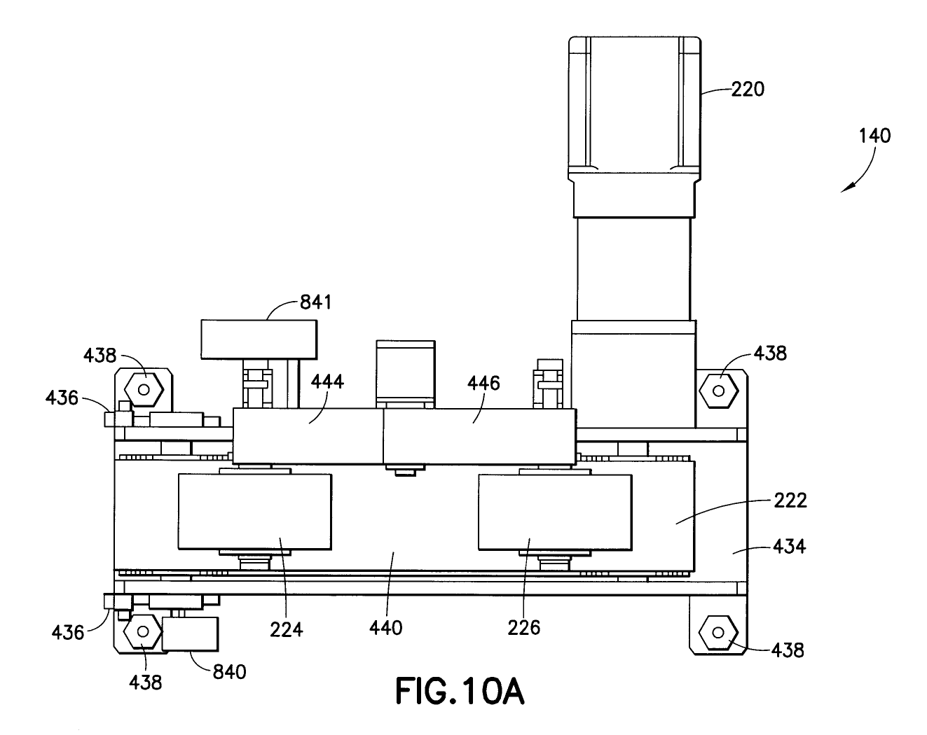

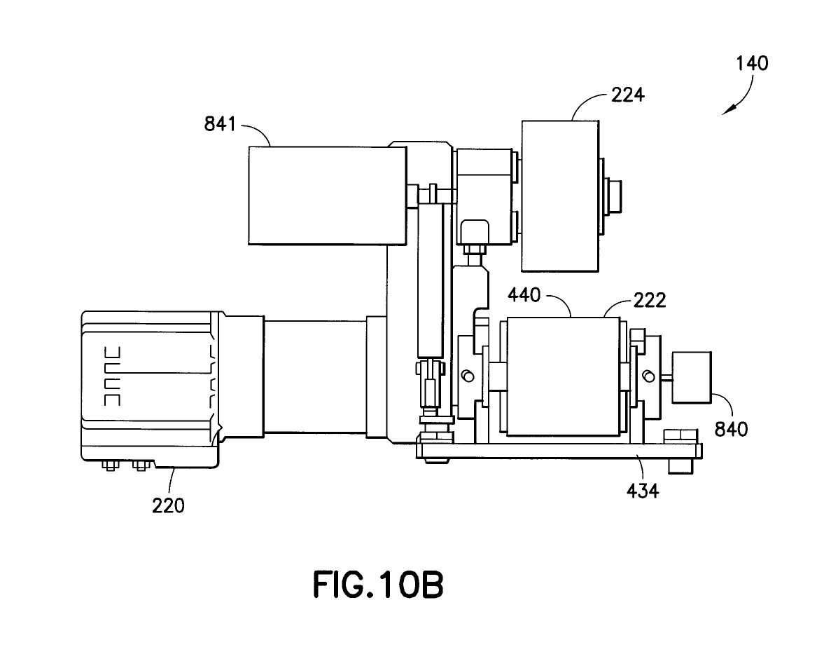

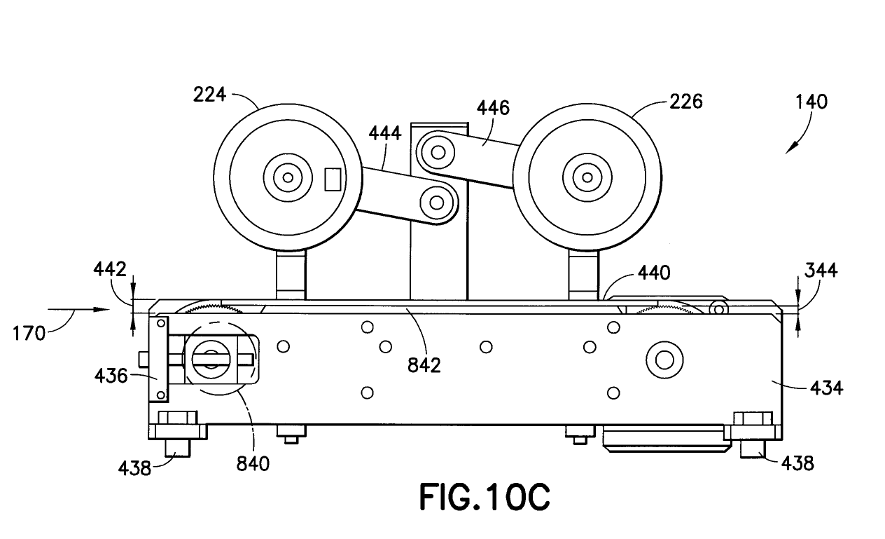

Referring now to FIG. 9A, there is shown a front isometric view of a conveyor clamp 140. Referring also to FIG. 9B, there is shown a rear isometric view of a conveyor clamp 140. Referring also to FIG. 10A, there is shown a top view of a conveyor clamp 140. Referring now to FIG. 10B, there is shown a side view of a conveyor clamp 140. Referring also to FIG. 10C, there is shown a front view of a conveyor clamp 140. Clamping and metering conveyor 140 has servo drive 220 which drives friction timing belt 222 via driven pulley 430 and slave pulley 432. Drive 220 and pulleys 430, 432 are mounted in frame 434 and having adjustable tensioners 436 located thereon. Leveling screws 438 are provided to level pulleys 430, 432 relative to the plane of travel 170. Servo drive 220 may have a servo motor, encoder and gear reduction as required to provide sufficient torque to drive belt 222 and hence material located thereon as a friction drive. A secondary encoder 840 may be applied, for example on slave roller 432 and can be used to check or synchronize with the leading edge of the material or used to drive the printer and add a vertical line to the material at a trailing edge such that if the line shows after the cut, the operator knows there is an error. In alternate embodiments, secondary encoder 841 may be applied, for example on slave roller 224 and can be used to check or synchronize with the leading edge of the material and used on either or both of the in-feed or out-feed sides and on either metering conveyor or independent of either metering conveyor where encoder 841 is used in conjunction with the leading edge detector as a primary material position detection device or alternately used as a check to determine if an error occurs by slippage or otherwise. Friction belt 222 resides on pulleys 430, 432 and after leveling may reside with a belt surface 440 above the normal path 170 an engagement distance 442, for example, 0.060″ above the plate or path. In alternate embodiments, more or less material engagement may be provided. Bed 842 is shown offset from drive wheel 430 and slave wheel 432, for example by 0.100″ where the friction belt 440 has pure linear motion such that if the belt surface wears, the accuracy of the drive is not affected and as such, frequent calibrations are not required. Belt 222 may have a friction coating, and may for example, be Brecoflex 3″ wide with PVC-Blue backing. Pressure rollers 224, 226 have springs and cylinders which drive the material along path 170 against belt 222 such that the material will not slide with respect to belt 222 when driven. Rollers 224, 226 may be urethane coated rollers or may have any other suitable surface to engage the material to be moved along path 170. Rollers 224, 226 have bearings mounted therein and are fastened to pivot links 444, 446 respectively with shoulder screws or otherwise. Rollers 224, 226 are forced to pivot in the direction of belt 222 by cylinders 228, 230 respectively, both of which may have limit sensors whereby the extremes of motion or selected intermediate points of motion may be monitored and interlocked as appropriate. Cylinders 228, 230 are provided with one end coupled to pivot links 444, 446 and the other coupled to frame 434. Different pressures may be applied to cylinders 228, 230 during different operations. For example a lower pressure may be applied when moving material as opposed to when cutting material with saw 52. Springs (not shown) may be provided between links 444, 446 and frame 434 to further bias rollers 224, 226 against the material being transported.

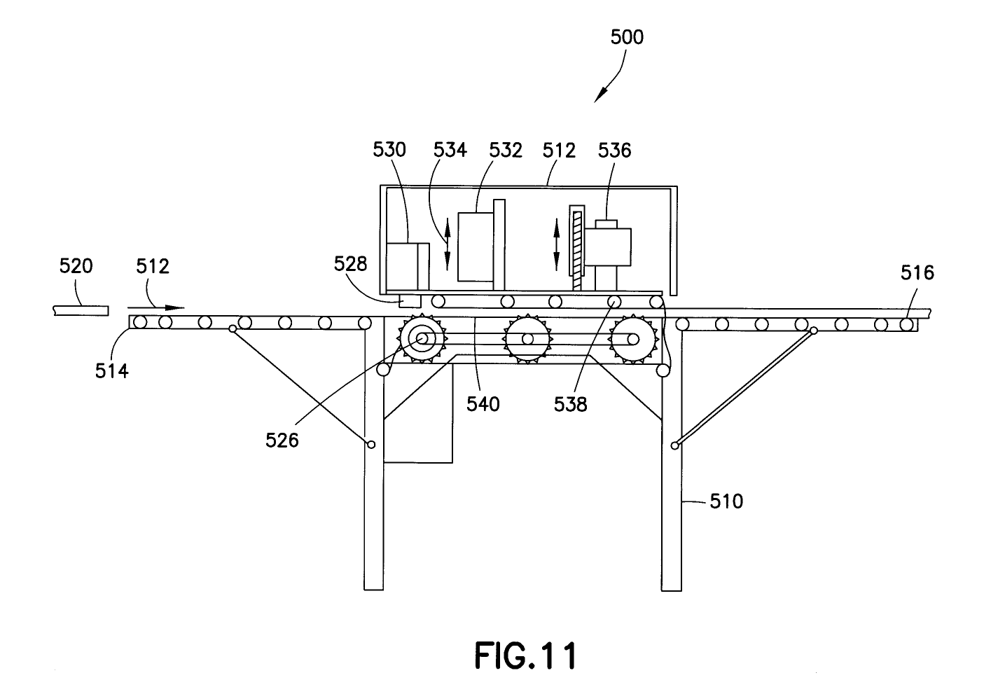

Referring now to FIG. 11, there is shown a front view of an alternate embodiment automated stick system 500. System 500 has features similar to system 20 but is configured differently as described below. System 500 has frame 510 and safety shield 512. Input conveyor 514 and output conveyor 516 are also provided where material 520 is transported along path 522. Conveyor drive with position feedback 526 is provided to transport material through system 500. Leading edge sensor 528 is provided to detect the leading edge of material 520 to be processed. Ink jet printer 530 is provided to mark material to be processed as previously described. Drill 532 may be provided having an automatic vertical drive 534 to drill features in material 530. Chop saw 536 which may or may not have miter capability is further provided. Pressure wheels 538 are also provided to provide sufficient pressure against driven belt 540 to ensure no slippage and thus accurate cut lengths based on the coordination of conveyor drive with position feedback 526 and leading edge sensor 528. In alternate embodiments, more or less features may be provided.

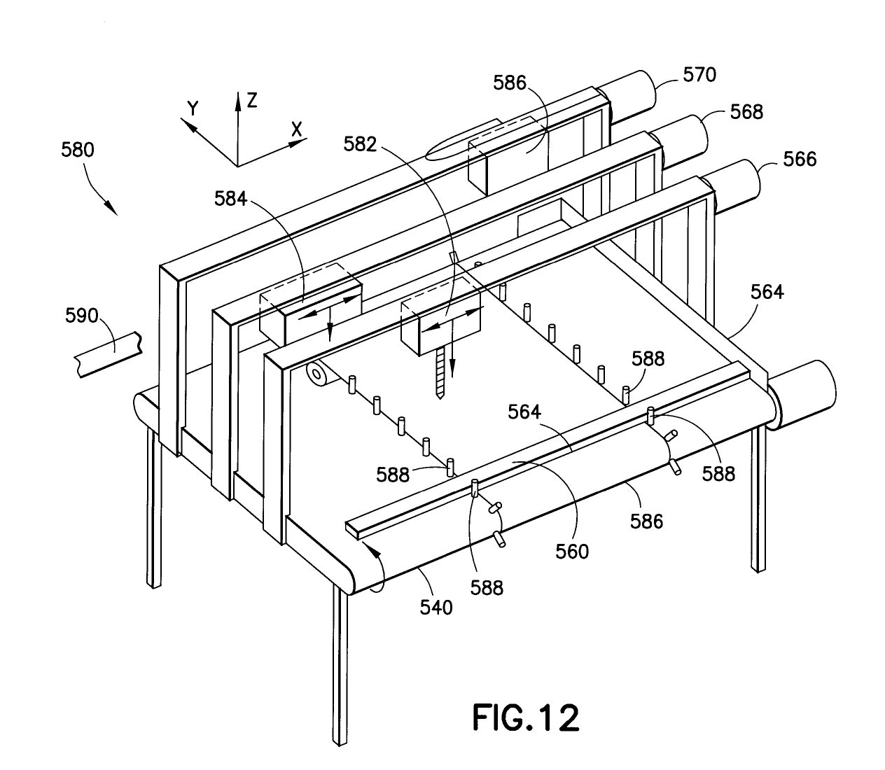

Referring now to FIG. 12, there is shown a isometric view of an automated stick system 580. In the alternate embodiment shown, a “side feed” stick machine is provided. Here, conveyor with position feedback 586 is provided with pins 588 where material 560 is placed between pins 588 and against reference edge 564. Conveyor 586 may move continuously or intermittently in-feed direction 564 where material 560 may be processed stationary or while moving. Pins 588 may be removable and replaceable, for example, to provide a fit spacing for different types of lumber. Drill gantry 566, saw gantry 568 and ink jet gantry 570 are provided as three potential process types on system 580. Drill gantry 566 has a gantry portion that moves drill 582 in the x-y plane where drill 582 may engage material by moving in the z direction. Saw gantry 568 has a gantry portion that moves saw 584 in the x-y plane where saw 584 may engage material by moving in the z direction. Ink jet gantry 570 has a gantry portion that moves ink jet printer 586 in the x-y plane where the ink jet portion 586 may engage material by moving in the z direction. In each case, the x, y and z motions cooperate with the motion of the conveyor 586 to process the material where output conveyor 590 collects processed lumber or material. It is noted that system 580 is capable of parallel operations, for example printing and drilling on the same or different pieces of material to be processed at the same time, on multiple pieces of material to be processed and may process a broad variety of materials, including lumber, sheathing, sheetrock or other suitable materials. In alternate embodiments, more or less features may be provided.

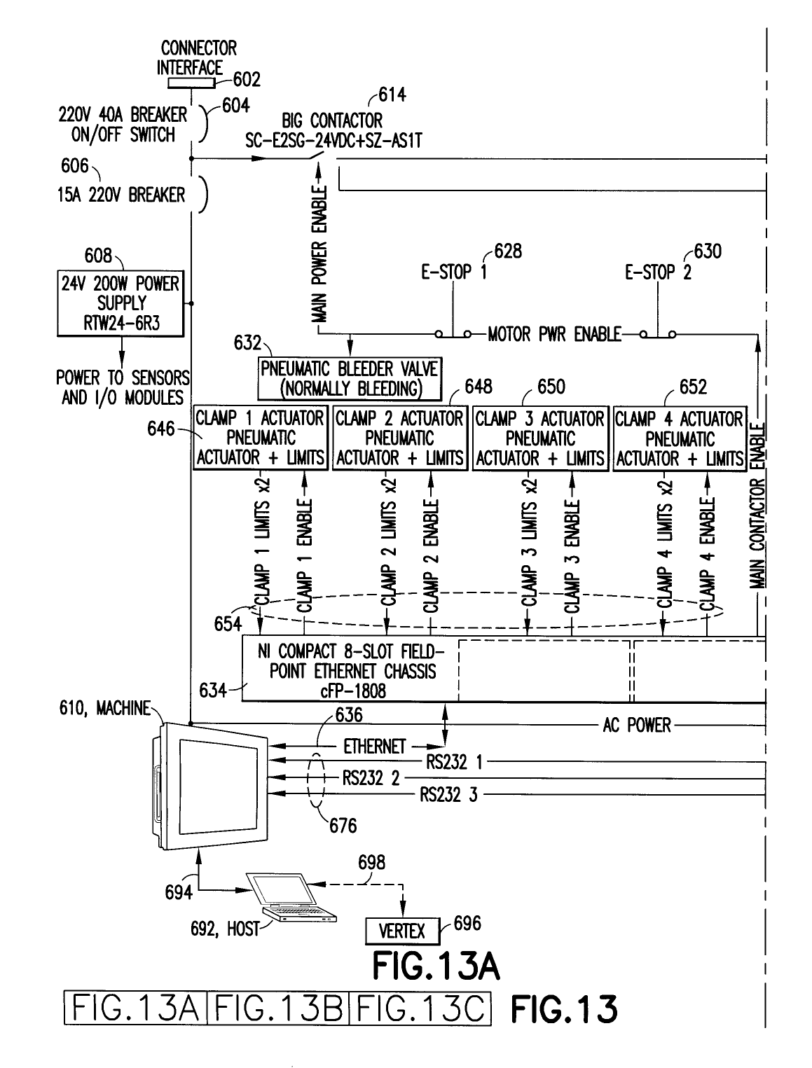

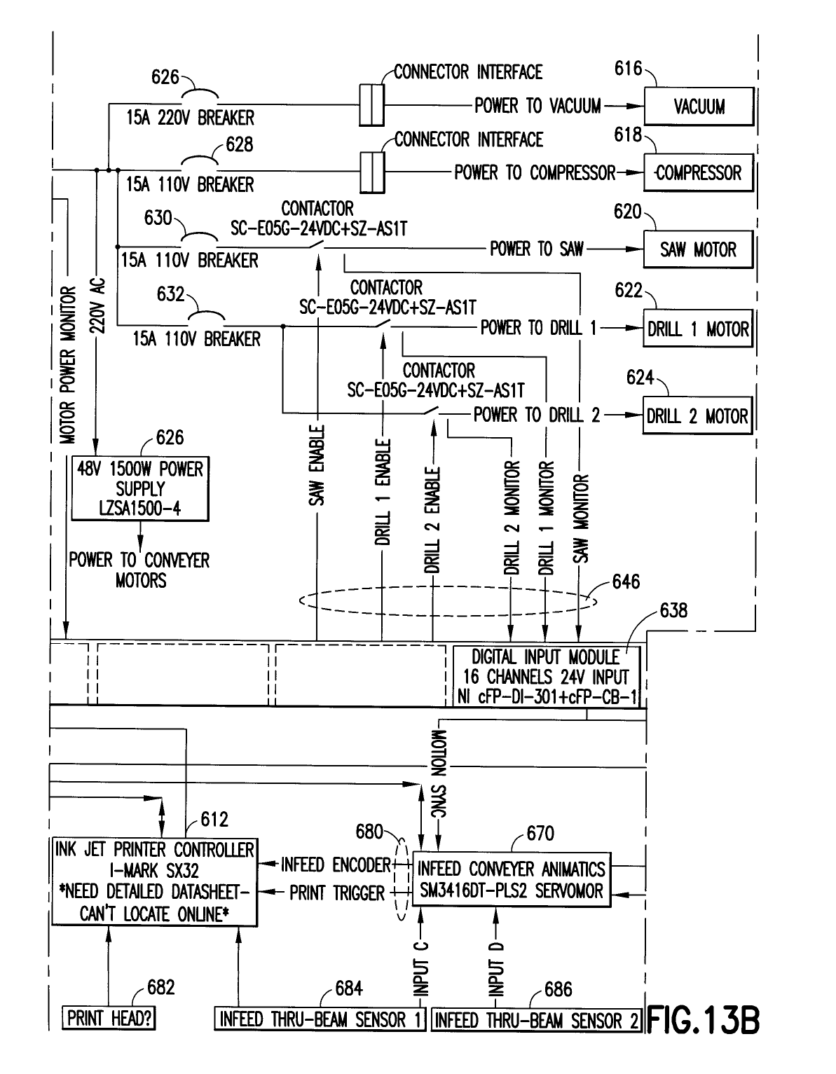

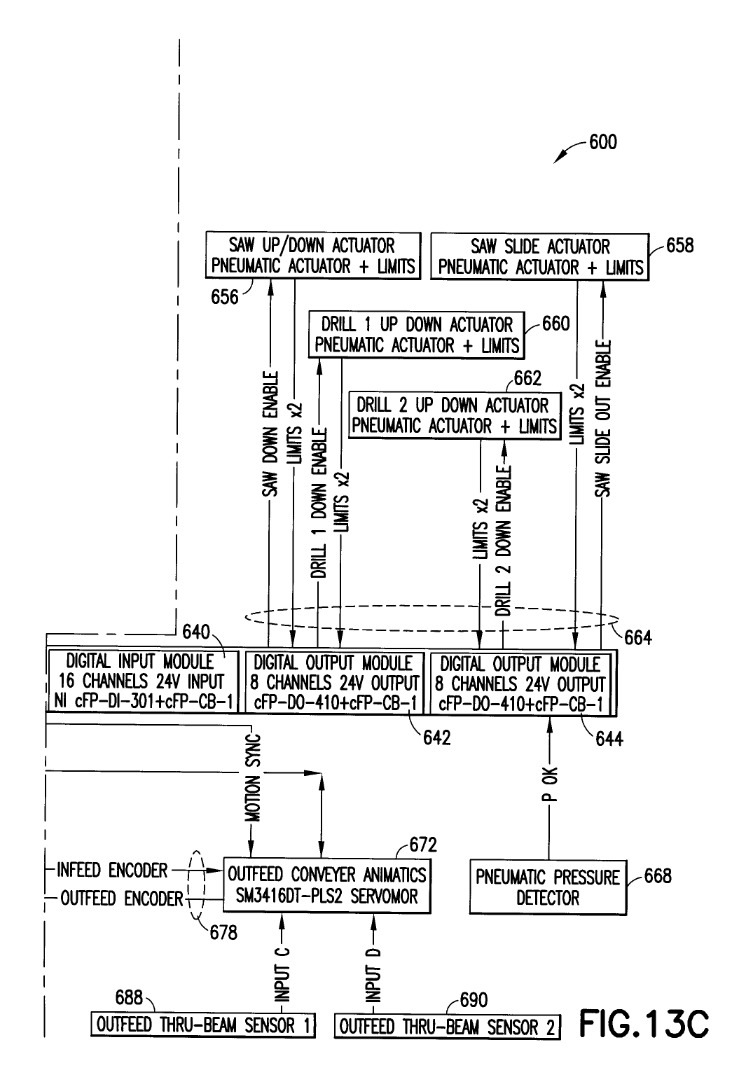

Referring now to FIG. 13, there is shown a block diagram of an automated stick system 600. Power source is connected to connector interface 602 with main breaker and on/off switch 604. Breaker 606 is provided to disconnect power from 24V powers supply 608 (for supplying sensors and I/O modules), tool controller 610 and ink jet print controller 612. Contactor 614 is provided to disconnect power from vacuum source 616, compressor 618, saw motor 620, drill 1 motor 622 and drill 2 motor 624, each having breakers 626, 628, 630 and 632 (shared by both drill 1 and 2) respectively as shown. Contactor 614 is further provided to disconnect power from 48V power supply 626 (used to power conveyor servo motors). Emergency stops 628, 630 are provided to disable power from motors where an e-stop condition may exist. With an e-stop event, power and air are shut off/dumped but logic remains active. Light tower 816 may be provided with color indicators to identify status of the tool and a visual indication of productivity. For example, blue may indicate waiting for a job, green may indicate the tool has a job and is ready to be loaded, red may indicate a job is being processed/do not load and flashing red may indicate an error or being programmed. Pneumatic bleeder valve 632 (normally bleeding) is also provided as shown. Ethernet chassis 634 is provided for I/O and communication and connected to controller 610 via ethernet connection 636, the chassis having input modules 638, 640 and output modules 642, 644 interfacing with, for example, enable and monitor signals 646. Clamp 1-4 actuators and limits 646, 648, 650, 652 interface with chassis 634 via limit inputs and enable signals 654. Saw up/down actuator 656, saw slide actuator 658, drill 1 up/down actuator 660 and drill 2 up/down actuator 662 interface with chassis 634 via limit inputs and enable signals 664. Pneumatic pressure detector 668 also interfaces with chassis 634. Ink jet print controller 612, Infeed conveyor servo drive 670 and Outfeed conveyor servo drive 672 interface with controller 610 via serial communication 676 or any suitable communication. Infeed and outfeed drives share encoder signals 678 while the print controller shares position signals and print trigger signal 680 as shown. Print controller 612 may interface with external print head 682 and/or thru beam sensor 1 684. Thru beam sensors 1 and 2 684, 686 interface with infeed conveyor servo drive 670. Thru beam sensors 2 and 3 688, 690 interface with outfeed conveyor servo drive 672. System 600 may operate in a stand alone manual or semi-automatic mode using only machine controller 610. In alternate embodiments, system 600 may operate in an automatic mode where host controller 692 interfaces with tool controller 610 over ethernet interface 694 or any other suitable connection or network. Here, controller 692 may have a .NET framework on a windows machine that can accept an incoming XML data 698 from Vertex drawings. Vertex tool 696 may generate XML data for a specific construction entity such as a wall or roof, floor etc. of a house. This XML data may then be parsed and a job file is generated via controller 692 software. In alternate embodiments, XML data may be imported directly to tool controller 610. Controller 692 software may then submits the program details as a “driver job” to machine controller 610 where the driver is a specific set of instructions that will engage machine 600 to process the material, for example, to either draw a marker, drill a hole or cut the stick at specific locations or other suitable process. In the embodiment shown, host controller may have a database and operational characteristics as described in U.S. Provisional Patent Application Ser. No. 61,362,145 Filed Jul. 7, 2010 entitled “CONSTRUCTION CONTROL SYSTEM” and the non provisional United States patent application which claims priority there to, both of which are hereby incorporated by reference herein in their entirety. Host or construction control system 692 may be capable of managing material and workflow for residential or other construction and may comprise a Residential Homebuilding Material Control System (RHMCS) 692 that may maintain all item and location data real time for design, millwork and construction phases (real-time as-built) where system 692 enables efficient material ordering, scheduling, dispatch, job execution, material management, control of automation, placement of materials, human safety pace-setting, and compliance to codes green initiatives. Feedback into system 692 may include data transmitted from controller 610 which may be on or off site, for example, status of task or position of automation and material from local position feedback system(s). System 692 may include full visualization capability for remote monitoring of system 600 or otherwise. In the embodiment shown, system 20 may able to update some or all data as required and adjust some or all elements in case of variances, exceptions or changes in-feedback, for example, variances in material as cut or as modified by system 600. As such, homebuyer or builder modifications may be accommodated real time while minimizing cost and schedule impact. Server 20 may be provided with an end-to-end interface and protocol (common language) to further facilitate efficient communications and interaction between database 692 and system 600 with controller 610. Construction control system 610 generally may have a server having access to a database where the server 30 may communicate with modules, such as Vertex CAD module 696 and CNC machine(s), for example system 600 via controller 610 where the database 692 has temporal data 70 associated with real time dynamic knowledge of the items, such as lumber and workflow such as a work and material schedule associated with system 600. In the embodiment shown, real time dynamic knowledge may include any attribute associated with the construction project or the use, operation and status of system 600. By way of further example, the real time dynamic knowledge of the items may include information and data in the database identifying at least one predetermined characteristic of an item or group of items or material based on both a design condition and a variance from the design condition where at least one predetermined characteristic of an item includes information related to a variance relative to the design condition. In the embodiment shown, system 692 may provide end to end integration of all aspects of the construction project, for example, design, millwork, construction and materials processing or otherwise. The database 692 may dynamically generate materials matched to data and content from the design as changes or variances occur and may provide fabrication sequencing of lumber to be processed by system 600 to facilitate efficient assembly of a portion of the construction in an efficient sequence. Database 692 may be updated continuously or as needed by controller 610 with status and state data associated with job(s) being executed by system 600 where state model is updated as well. System 600 may interact with relational database and management software 692 with any suitable data 694 in a two way fashion, for example including status, CNC files, change requests, job status, tool status, errors, variances, dispatch, instructions, status, material and tool or other component positions, exceptions or otherwise. In the embodiment shown, system 600 may be provided to manufacture lots of lumber, for example CNC cutting, identification, drilling for electrical or plumbing, marking circuits, elec boxes etc. . . . . In alternate embodiments, more or less functions may be provided. System 600 may receives CAD data translated from framing model in server 692 where system 600 may cut boards to length and may be provided with adjustable miter and bevel, drills holes for electrical and plumbing, marks, for example, board ID, stud locations, hole ID-electrical circuit or plumbing ID, electrical outlet locations, switch locations, data cables, drilled holes for pinned connections to bottom of panels, top of panels or at stud locations to permit alignment or otherwise. System 600 may be fed material or lumber and may prompt a user or automated supply system to load appropriate board length that minimizes waste of parts to be produced. Controller 610 may accept an incoming CNC data, for example data for a specific construction entity such as a wall or roof, floor etc. of a project where the data may be parsed and a job file generated as a specific set of CNC instructions that will engage the machine to either draw a marker, drill a hole or cut the stick or otherwise provide predetermined features or attributes at specific locations on the material.

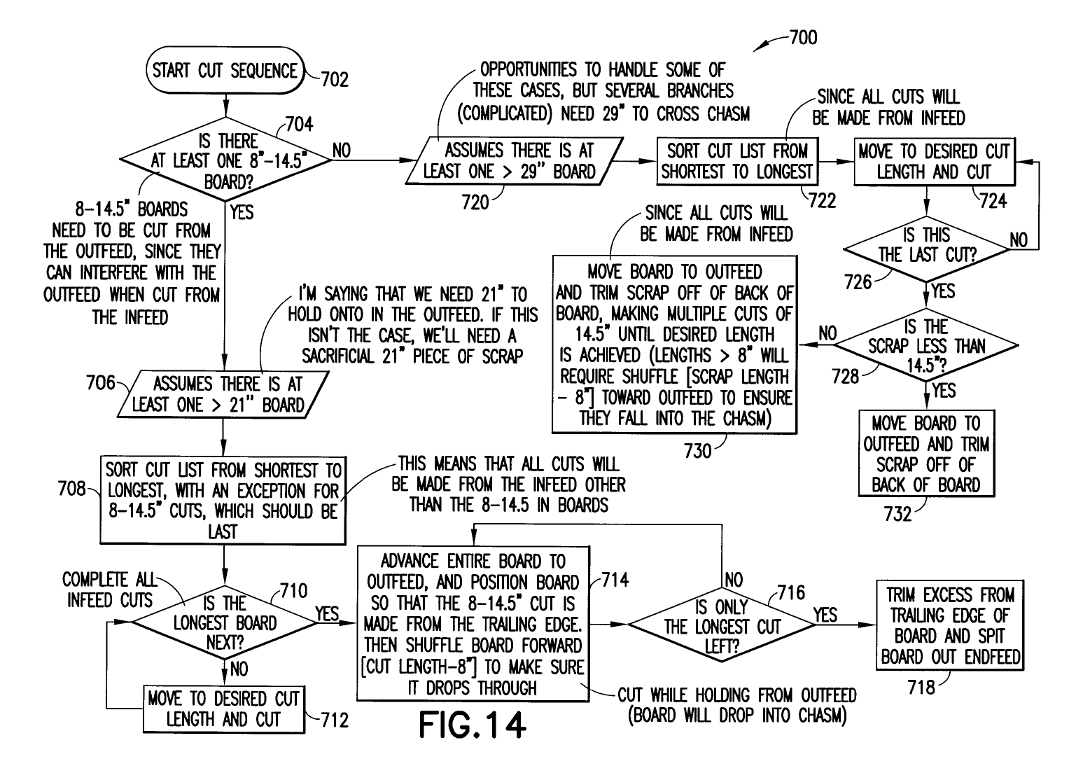

Referring now to FIG. 14, there is shown a process flow diagram of an automated stick system 700. The process starts at 702 and at 704 checks if there is at least one 8″-14.5″ board as they need to be cut from the outfeed so as not to interfere with the outfeed if cut from the infeed. If so, the system assumes 706 that there is at least 1 21″ or longer board to hold onto in the outfeed (if not, then a 21″ piece of sacrificial scrap is needed). The system then sorts 708 the cut list from shortest to longest with an exception for 8-14.5″ cuts which are reserved for last. Infeed cuts are completed where if the longest cut is not next 710, the system moves 712 to the desired cut length and cuts. Where the longest board is next 710, the board is advanced to the outfeed and the 8-14.5″ cut is made from the trailing edge 714 where the board is shuffled forward (cut length)-8″ to make sure it drops through below the saw, for example, into a scrap bin. The system returns to step 714 if the longest cut is not left 716; otherwise it proceeds to 718 where the system trims the excess from the trailing edge of the board and sends the board out of the outfeed. Returning to the top left of the flow chart, if at 704 there is not at least one 8″-14.5″ board, the system assumes there is at least one board greater than 29″ in length 720 and sorts 722 the cut list from shortest to longest. The system sequentially moves the material to the desired cut length and cuts 724 until the last cut is complete 726 where it proceeds to determine if the scrap is less than 14.5″ 728. If not, the system proceeds to move the board to the outfeed conveyor and trims the scrap off the back making multiple 14.5″ cuts 730. If so, the system proceeds to move the board to the outfeed conveyor and trims the scrap off the back 732. I alternate embodiments, the cut lengths, scrap lengths or otherwise may be more or less, for example, where the infeed and outfeed conveyors are closer together, such as ½″ apart and sufficient for blade clearance alone.

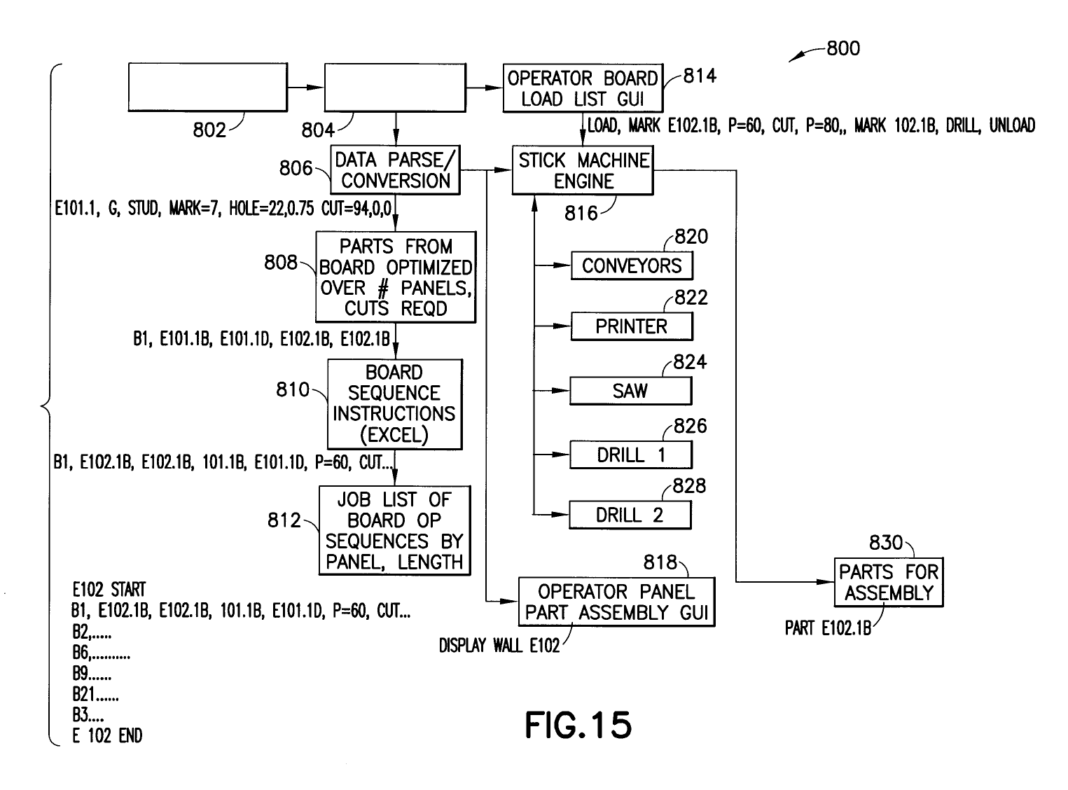

Referring now to FIG. 15, there is shown an exemplary process flow diagram of an automated stick system 800. Vertex CAD software 802 outputs XML data parts files 804. Parts files 804 are parsed and converted 806 and parts from a given board are optimized 808, for example over the number of panels and cuts to minimize scrap and maximize efficiency. Board sequence instructions 810 are developed, for example in .XLS excel format and a job list 812 of board operation sequences, for example, by panel and length is developed. The Job list 812 feeds the operator board load list GUI 814, the stick machine engine 816 and the operator panel part assembly GUI 818. Stick machine engine 816 interfaces machine components such as with conveyors 820, printer 822, saw 824, drill 1 826 and drill 2 828. Stick machine engine 816 in conjunction with the physical machine components in an automated fashion generates the parts for assembly 830 based on job list 812. Subsequent parts and kits of parts may be generated by repeating or generating and executing additional job list(s).

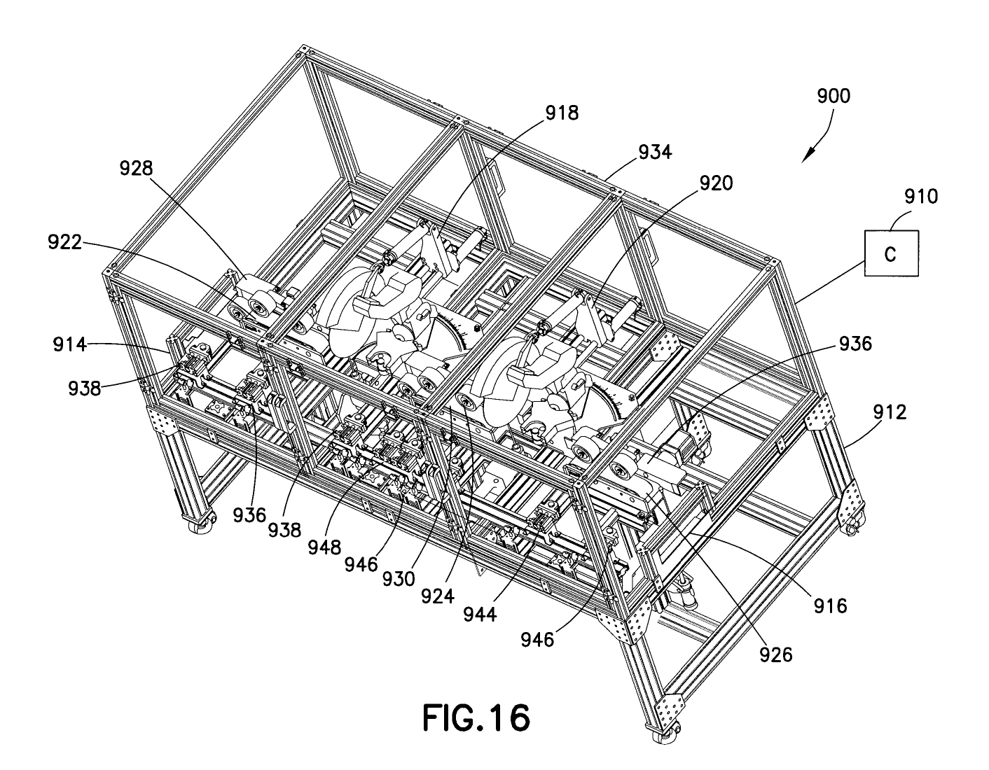

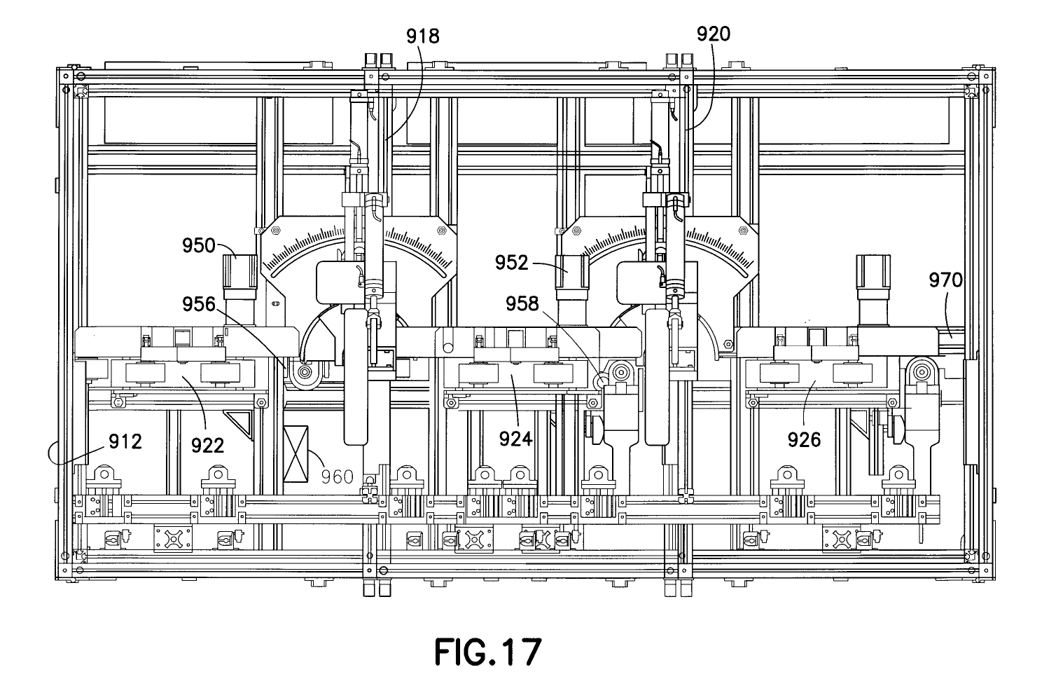

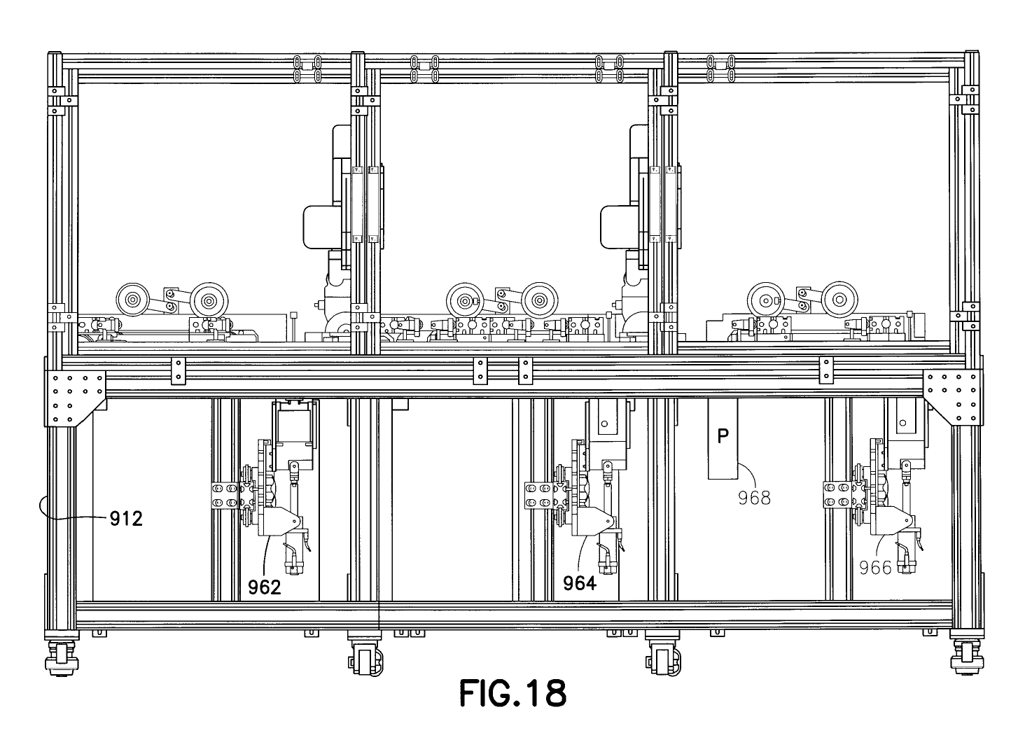

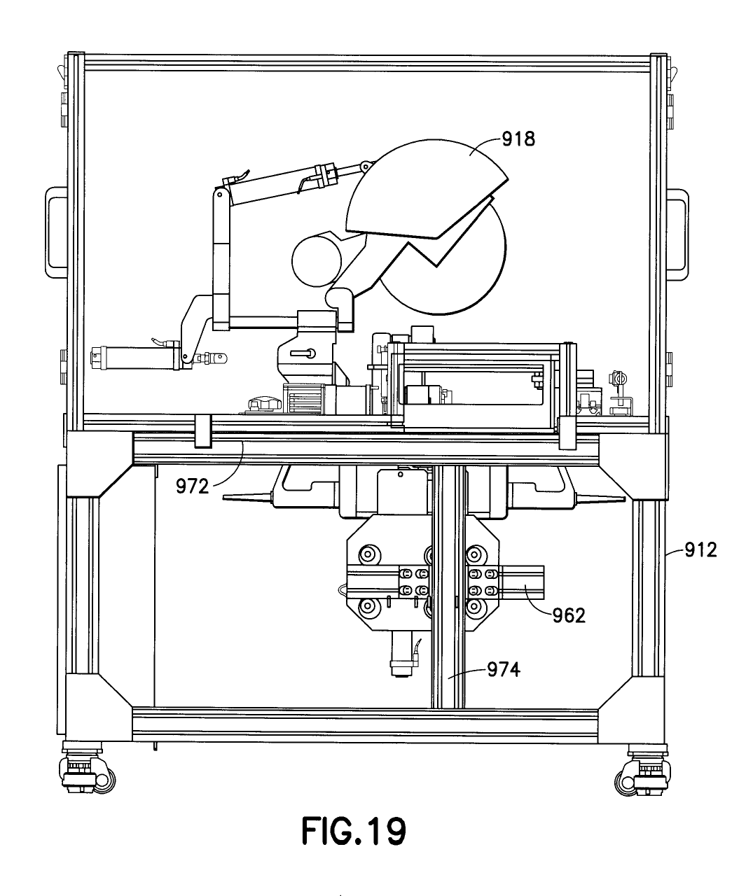

Referring now to FIG. 16, there is shown an isometric view of an automated stick system 900. Referring also to FIG. 17, there is shown a top view of an automated stick system 900. Referring also to FIG. 18, there is shown a front view of an automated stick system 900. Referring also to FIG. 19, there is shown a side view of an automated stick system 900. Automated stick system 900 may be provided with features as disclosed in previous embodiments where previous embodiments may be provided with features as disclosed with respect to automated stick system 900. Automated stick cutting system 900 is shown adapted to produce stick-frame construction components from material for building construction. Automated stick cutting system 900 has controller 910 and frame 912, in-feed portion 914 and out-feed portion 916. First and second saws 918, 920 are shown interfacing with controller 910 and are adapted to cut material such as to cut a cut feature on the material, with saws 918, 920 coupled to frame 912. A feed drive having metering conveyors 922, 924, 926 is shown coupled to frame 910, the feed drive interfacing with controller 910 and adapted to feed and position the material relative to frame 912. The feed drive may have in-feed drive 922, intermediate drive 924 and out-feed drive 926 where in-feed drive 922 may be an in-feed metering conveyor and where intermediate drive 924 may be an intermediate metering conveyor and where out-feed drive 926 may be an out-feed metering conveyor. In-feed drive 922 is shown coupled to frame 912, in-feed drive 922 adapted to accept the material from in-feed portion 914 and feed the material to saw 918, 920. Guide 928, 930, 932 is shown coupled to frame 912, guide 928, 930, 932 adapted to guide an edge of the material. Side clamps 934, 936, 938, 940, 942, 944, 946 are shown adapted to selectively clamp the material against guide 928, 930, 932 while the material is being cut by either saw 918 or saw 920. In the embodiment shown, with the two saws and three feed drives, material may be simultaneously fed and cut or have features added. Position detectors 950, 952 may be encoders or otherwise and are shown coupled to frame 912, the position detectors adapted to track a position of the material relative to in-feed drive 922, intermediate drive 924 and out-feed drive 926. The position detectors may measure the position of the material independent of a position of any of the feed drives, in-feed drive 922, intermediate drive 924 and out-feed drive 926 or otherwise, for example, where a different encoder is provided with a wheel slaved off of a surface of the material where the encoder detects the position of the material independent of any slippage of the feed drive(s). Out-feed drive 926 is shown adapted to accept the material uncut from intermediate drive 924, out-feed drive 926 adapted to accept the material cut from saw 920 and feed cut material to out-feed portion 916. In the embodiment shown, in-feed portion 914 may define an in-feed opening of enclosure 954 and out-feed portion 916 may define an out-feed opening of enclosure 954, where enclosure 954 defines a safety barrier that prevents user access to saws 918, 920 or other component of system 900, for example, during a cutting operation of the saw or other suitable operation of another component of system. Edge detectors 956, 958 are shown adapted to detect a leading edge of the material when being fed to saws 918, 920 by respective drives. Position detectors 950, 952 and edge detectors 956, 958 cooperate with operation of the saws to meter lengths of the material through the feed drives and to cut predetermined length(s) of the material with saws 918, 920. Printer 960 may be coupled to frame 912, printer 960 adapted to print a printed feature on the material, for example, on at least one side of the material. In alternate embodiments, more than one printer may be provided with suitable positioning actuator(s) or mounting to selectively print features on one or more surfaces of the material being processed. Drills 962, 964, 966 are shown coupled to frame 912, the drills adapted to drill a drilled feature on the material, for example, on at least one side of the material. Pin setter 968 is shown coupled to frame 912, pin setter 968 adapted to set a pin feature on and in the material, for example, on at least one side of the material. In alternate embodiments, more than one device or additional similar or different device(s) may be provided with suitable positioning actuator(s) or mounting to selectively provide features on one or more surfaces of the material being processed. In the embodiment shown, controller 910 interfaces with saws, feed drives, printer, drills and the pin setter to selectively position a set of predetermined features on the material. Automated stick cutting system 900 may be provided as a configurable automated stick cutting system, for example, where frame 912 is shown having predetermined mounting features 970, 972, 974 configured to mount additional components there to, the additional components configured to interface with the controller 910 and to selectively position a set of predetermined features on the material. For example, the additional components may be one or more of a printer adapted to print a printed feature on the material; a drill adapted to drill a drilled feature on the material and a pin setter adapted to set a pin feature on the material. As will be described in greater detail below, automated stick cutting 900 system may be a transportable platform, for example, with frame 912 coupled to transportable platform, where transportable platform is transportable from a first work site to a second work site. By way of example, frame 912 may be coupled to a trailer or truck, where the trailer or truck is transportable from a first work site to a second work site. As previously described, controller 910 may interface with a database, the database providing controller 910 with the set of predetermined features to be applied to the material, with controller 910 adapted to report a status relating to application of the set of predetermined features to the material to the database. For example, the predetermined features may be one or more of a cut feature, a printed feature a drilled feature a pin feature or otherwise. In alternate embodiments, more or less components or features may be provided.

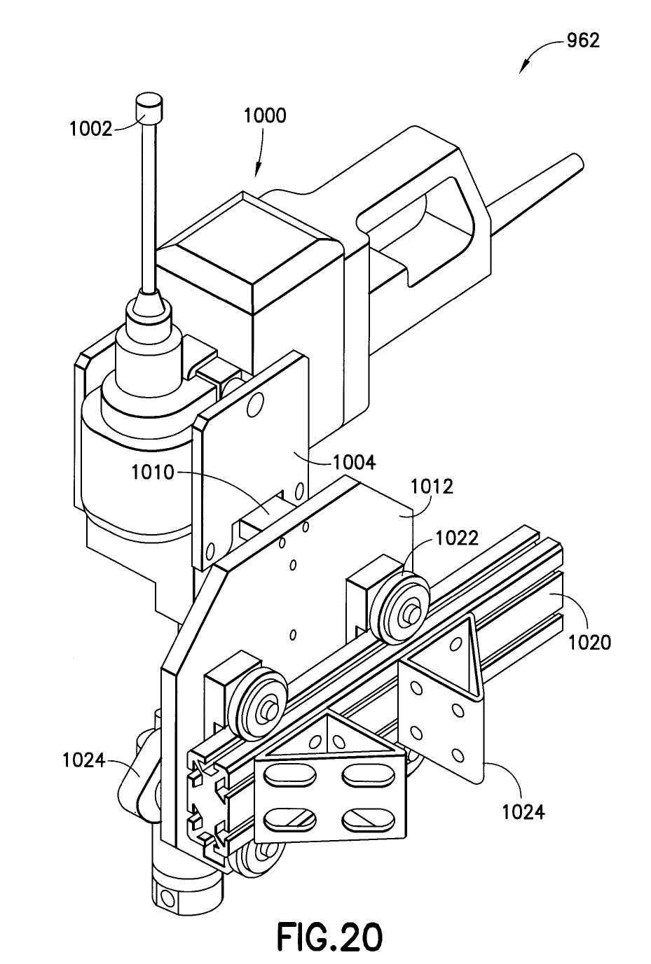

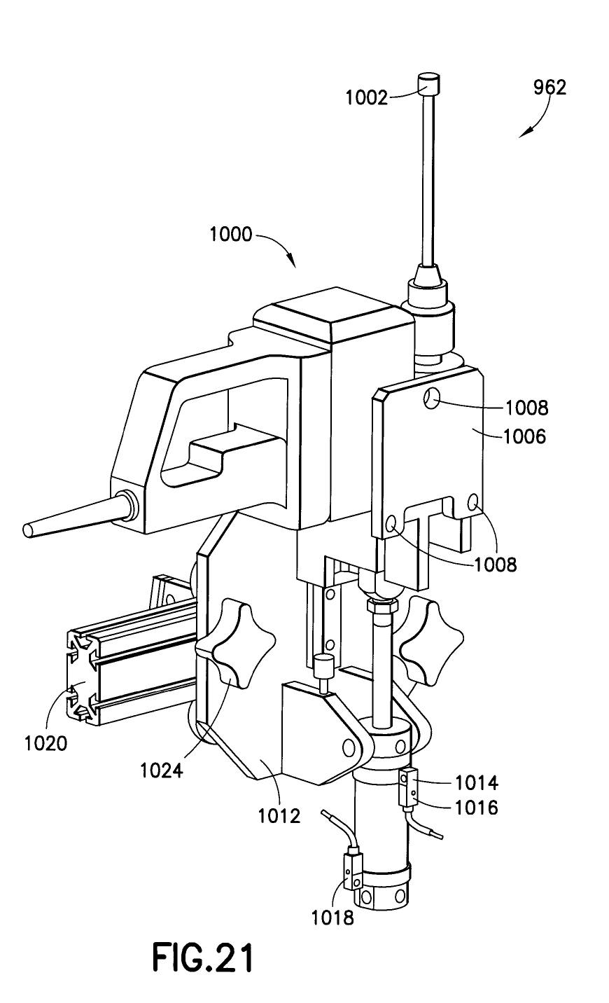

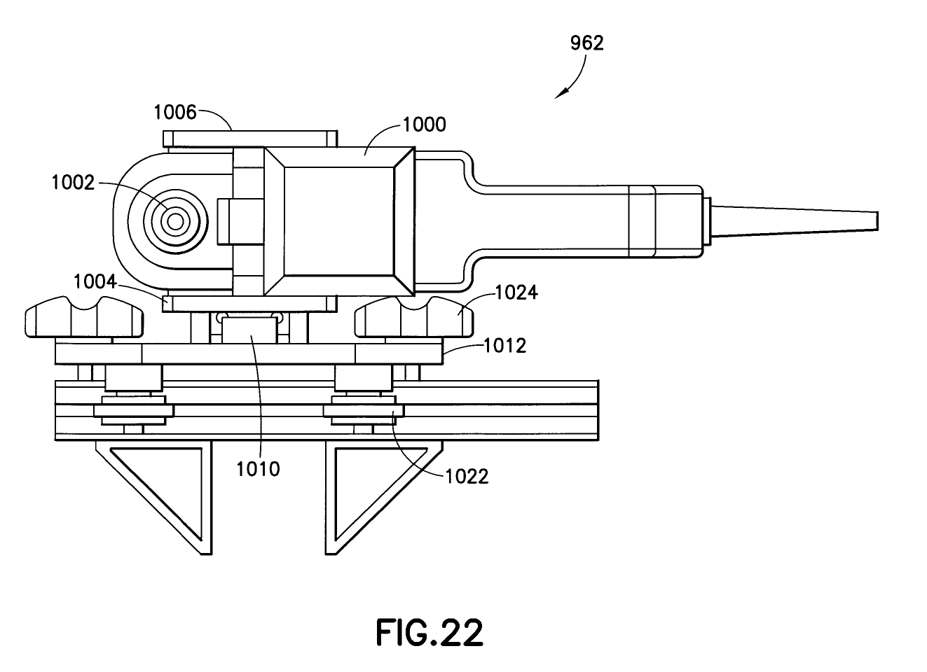

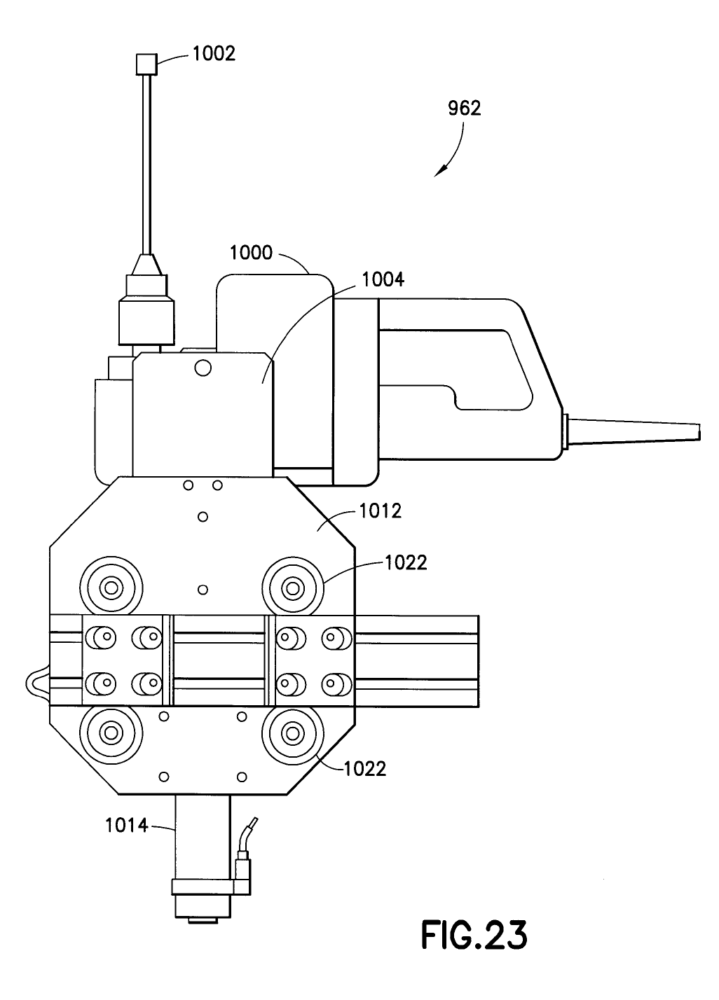

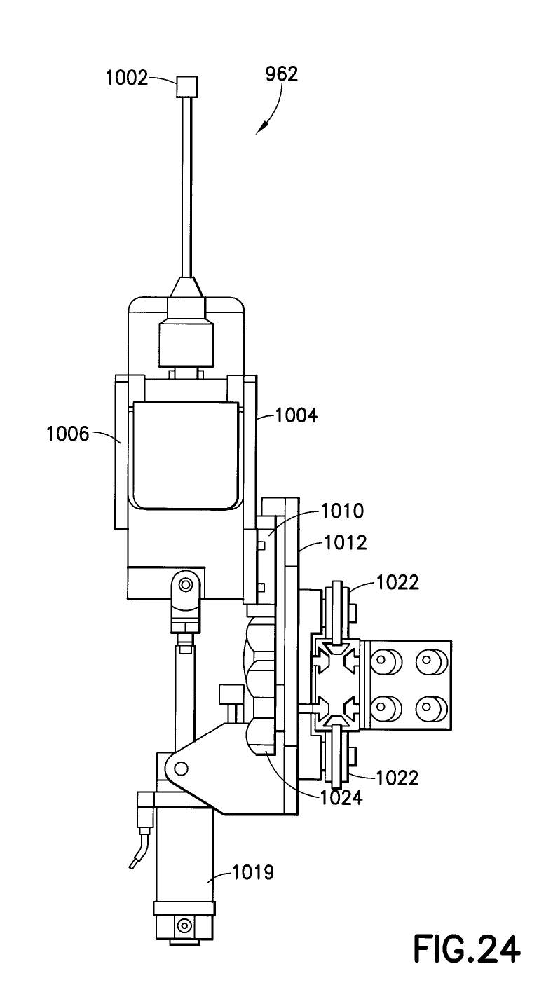

Referring now to FIG. 20, there is shown an isometric view of drill 962. Referring also to FIG. 21, there is shown an isometric view of drill 962. Referring also to FIG. 22, there is shown a top view of drill 962. Referring also to FIG. 23, there is shown a side view of drill 962. Referring also to FIG. 24, there is shown a front view of drill 962. Drill 962 has drive 1000 with bit 1002 which may be a commercially available drive, for example, as manufactured by Milwaukee or otherwise. Drive 1000 is removably mounted to vertically moveable carriage 1004 with plate 1006 and fasteners 1008. Slide 1010 couples carriage 1004 to frame 1012 where carriage 1004 is vertically movable between an extended position and a retracted position by cylinder 1014 having respective position sensors 1016, 1018 and where in the extended position, bit 1002 engages material to be drilled, slotted or otherwise having a predetermined feature placed there in at a predetermined depth. Although cylinder 1014 is shown as a two position device, any suitable actuator may be used, for example, a linear servo actuator with user selectable positions and depths may be used. Frame 1012 is movably coupled to bar 1020 with rollers 1022 and clamp knobs 1024 where loosening of knobs 1024 allows a user to adjust a position perpendicular to material travel and set a position of drill 962 with respect to the material. Although the position is shown manually adjustable, in alternate embodiments, a two position or variable position actuator may be provided and used in conjunction with the feed drive and vertical drive to provide programmable three dimensional features on a surface of the material. In alternate embodiments, more or less actuators may be provided where drill 962 may be angled or otherwise positioned to selectively provide further predetermined three dimensional features on the same or other faces of the material. Brackets 1024 are provided to mount drill 962 to predetermined mounting feature 974. In alternate embodiments, more or less components or features may be provided.

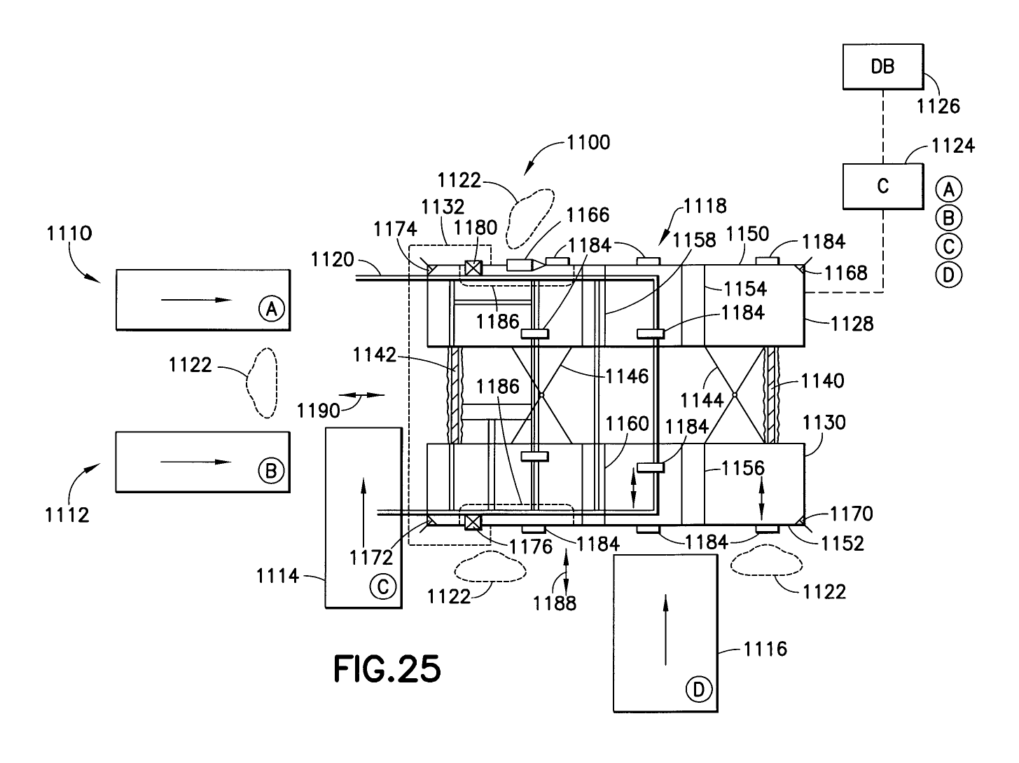

Referring now to FIG. 25, there is shown a top view of panel table 1100. Panel table 1100 has in-feed conveyors 1110, 1112, 1114, 1116 and flexible assembly table 1118. Panel table 1110 facilitates automatic or semi-automatic assembly of exemplary wall panel 1120 by user(s) 1122. Although panel 1120 is shown as a wall panel, any suitable panel may be assembled using system 1100. In-feed conveyors 1110, 1112, 1114, 1116 may be powered or manual rolling buffer tables where conveyors 1100, 1112 may be provided for smaller material, where conveyor 1114 may be provided for larger material and conveyor 1116 provided for sheathing or other material. Flexible assembly table 1118 may have controller 1124, supports 1128, 1130 and power enclosure 1132. Controller 1124 may drive and control components of and interface with table 1118, feed conveyors 1110, 1112, 1114, 1116, users 1122 or otherwise where controller 1124 may also interface with database 1126 in a manner as previously described with respect to the stick machine embodiments disclosed. Further, system 1100 may be provided with features as disclosed in previous stick machine embodiments where previous stick machine embodiments may be provided with features as disclosed with respect to system 1100. Supports 1128, 1130 are shown moveable in width with respect to each other to accommodate panels of different widths by motor driven screws 1140, 1142 and scissors guides 1144, 1146 where the width may be adjusted to match a panel height. Edge guides 1150, 1152 are provided to optionally constrain and align the edges of panel 1120 during assembly where guides 1150, 1152 may be vertically moveable to facilitate access and removal of panel 1120. Fork depressions 1154, 1156, 1158, 1160 may be provided to allow a fork truck, crane or other suitable transport to remove an assembled panel. Laser 1166 may be provided with corner prisms 1168, 1170, 1172, 1174 to provide a square reference. Nailers 1176, 1180 may be provided as automatic or semi automatic pneumatic driven or otherwise driven nailers to facilitate assembly of panel 1120. Nailers 1176, 1180 may be adapted to sense fiducials on components of panel 1120 where controller 1124 may selectively actuate nailers 1176, 1180 when the appropriate fiducials are sensed along with sensing location and presence of adjoining components with appropriate safety interlocks. Rollers 1184 may be provided to facilitate unloading of assembled panel 1120 where rollers 1184 may selectively be lifted to or otherwise engaged to allow panel 1120 to be supported while moved in direction 1188. Power feeder or rollers 1186 may be provided and may selectively be lifted to or otherwise engaged to allow panel 1120 to be supported while moved in direction 1190. Two separate power feeders 1186 are shown which may be driven together or independently to semi automatically or automatically correct for skew or otherwise. Enclosure 1132 may be provided to contain the heaviest portions of the drive components, power equipment or otherwise to allow the opposing end of table 1100 to have minimum weight. In alternate embodiments, more or less components or features may be provided.

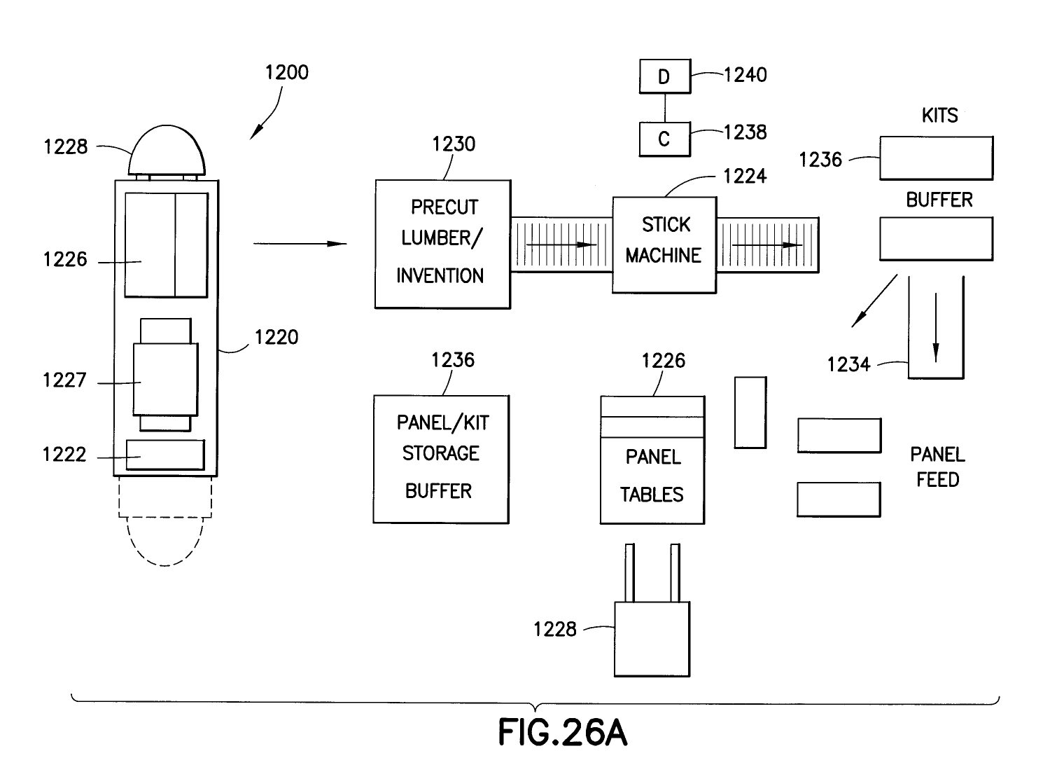

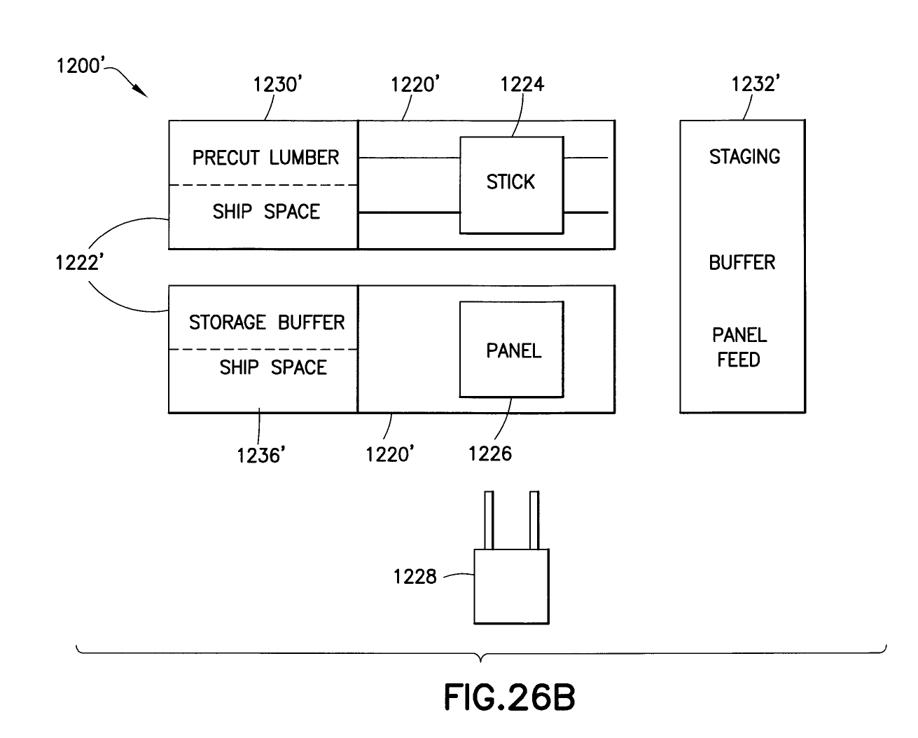

Referring now to FIG. 26A, there is shown a top view of portable stick cutting system 1200. Portable automated stick system 1200 is shown adapted to produce stick-frame construction components from material for building construction at a job site and transportable from job site to job site to facilitate local panel production. In the embodiment shown, the components that make up portable automated stick system 1200 are provided for shipping on transportable platform 1220 where transportable platform 1220 may have staging and conveyor shipping module 1222, stick machine 1224, panel table 1226 and transportable forklift 1228. Transportable platform 1220 may be a flat bed trailer, enclosed trailer, truck and trailer combination, container or other suitable means of transport. Here, transportable platform 1220 is shown transportable from a first work site to a second work site, where the transportable platform 1220 may be a trailer or a truck or otherwise transportable from a first work site to a second work site. Staging and conveyor shipping module 1222 may have broken down staging, racks conveyors, or other suitable components as needed to support panel production of system 1200. Stick machine 1224 and panel table 1206 may have features as described herein. Transportable forklift 1228 may be provided as a removable forklift, crane or other suitable transport device used to facilitate movement of equipment, components, lumber and/or panels. In the embodiment shown components of system 1200 are transported to a job site and unloaded, either completely or partially, to form a panel production line. The panel production line has pre-cut material staging portion 1230, automated stick cutting system 1224 and cut material buffering portion 1232. Material to be processed in automated stick cutting system 1224 is supported by and staged at pre-cut material staging portion 1230. Material that has been processed in automated stick cutting system 1224 is supported by and buffered at cut material buffering portion 1232. In the embodiments shown, automated stick cutting system 1224 processes the material by applying a set of predetermined features to the material. Panel table 1226 may be provided, where material buffered at the cut material buffering portion 1232 is provided to panel table 1226 and assembled into a predetermined panel configuration. Material buffered at cut material buffering portion 1232 may provided in a predetermined order to panel table 1226, the predetermined order corresponding to an order in which the material buffered are to be assembled into the predetermined panel configuration as determined by controller 1238 or database 1240 where controller 1238 may interface with components of system 1200 and interact with database 1240 as previously described with respect to the disclosed embodiments or otherwise. For example, controller 1238 may be provided interfacing with database 1240 providing controller 1238 with the set of predetermined features to be applied to the material where controller 1238 may be adapted to report a status relating to application of the set of predetermined features to the material. Here, the features may include physical features associated with individual pieces or material or lumber, features associated with raw inventory, pre assembled material or kits, panel configuration or geometry, or otherwise features associated with the production of panels. Further, database 1240 may provide controller 1238 with the predetermined order corresponding to the order in which the material buffered are to be assembled into the predetermined panel configuration, with the controller 1238 adapted to report a status relating to application of the set of predetermined features to the material and the assembly of the predetermined panel configuration. Conveyors 1234 and panel storage space 1236 may further be provided to facilitate panel production. In alternate embodiments, more or less components or features may be provided.

Referring now to FIG. 26B, there is shown a top view of portable stick cutting system 1200′. In the embodiment shown, transportable platform 1220′ may have first and second trucks or trailers, where the automated stick cutting system is supported by a first trailer, and where the panel table is supported by a second trailer. The components that make up portable automated stick system 1200′ are provided for shipping on transportable platforms 1220′ where transportable platforms 1220′ may have staging and conveyor shipping modules 1222′, stick machine 1224, panel table 1226 and transportable forklift 1228. Transportable platforms 1220 may be two flat bed trailers, enclosed trailers, truck and trailer combinations, containers or other suitable means of transport. Staging and conveyor shipping modules 1222′ may have broken down staging, racks, conveyors, or other suitable components as needed to support panel production of system 1200′. The panel production line has pre-cut material staging portion 1230′ which is derived from the space vacated upon unloading of staging and conveyor shipping modules 1222′, automated stick cutting system 1224 and cut material buffering portion 1232′ which may be built from staging, an additional trailer or at floor level. Material to be processed in automated stick cutting system 1224 is supported by and staged at pre-cut material staging portion 1230′. Material that has been processed in automated stick cutting system 1224 is supported by and buffered at cut material buffering portion 1232′. Panel table 1226 may be provided, where material buffered at the cut material buffering portion 1232′ is provided to panel table 1226 and assembled into a predetermined panel configuration. Panel storage space 1236 which is derived from the space vacated upon unloading of staging and conveyor shipping modules 1222′ may further be provided to facilitate panel production. In alternate embodiments, more or less components or features may be provided.

In accordance with one exemplary embodiment, an automated stick cutting system is adapted to produce stick-frame construction components from material for building construction. The automated stick cutting system has a frame having an in-feed portion and an out-feed portion. A saw is adapted to cut the material, the saw coupled to the frame. An in-feed drive is coupled to the frame, the in-feed drive adapted to accept the material from the in-feed portion and feed the material to the saw. A position detector is coupled to the frame, the position detector adapted to track a position of the material relative to the in-feed drive. An out-feed drive is adapted to accept the material uncut from the in-feed drive, the out-feed drive adapted to accept the material cut from the saw and feed cut material to the out-feed portion. An edge detector is adapted to detect a leading edge of the material when being fed to the saw by the in-feed drive. The position detector and the edge detector cooperate with operation of the saw to meter lengths of the material through the in-feed drive and to cut a predetermined length of the material with the saw.

In accordance with another exemplary embodiment, an automated stick cutting system is provided adapted to produce stick-frame construction components from material for building construction. The automated stick cutting system has a controller and a frame. A feed drive is coupled to the frame, the feed drive adapted to feed and position the material relative to the frame. A saw is coupled to the frame, the saw adapted to cut a cut feature on the material. A printer is coupled to the frame, the printer adapted to print a printed feature on the material. A drill is coupled to the frame, the drill adapted to drill a drilled feature on the material. A pin setter is coupled to the frame, the pin setter adapted to set a pin feature on the material. The controller interfaces with the saw, the feed drive, the printer, the drill and the pin setter to selectively position a set of predetermined features on the material.

In accordance with another exemplary embodiment, a configurable automated stick cutting system is provided adapted to produce stick-frame construction components from material for building construction. The configurable automated stick cutting system has a controller and a frame. A feed drive is coupled to the frame, the feed drive interfacing with the controller and adapted to feed and position the material relative to the frame. A saw is coupled to the frame, the saw interfacing with the controller and adapted to cut a cut feature on the material, the frame having predetermined mounting features configured to mount additional components there to, the additional components configured to interface with the controller and to selectively position a set of predetermined features on the material.

In accordance with another exemplary embodiment, a portable automated stick system is provided adapted to produce stick-frame construction components from material for building construction. The portable automated stick system has a transportable platform having a pre-cut material staging portion, an automated stick cutting system and a cut material buffering portion. Material to be processed in the automated stick cutting system is supported by and staged at the pre-cut material staging portion. Material that has been processed in the automated stick cutting system is supported by and buffered at the cut material buffering portion. The automated stick cutting system processes the material by applying a set of predetermined features to the material.

In accordance with another exemplary embodiment, a portable stick cutting system is provided adapted to produce construction components from material for residential homebuilding. The portable stick cutting system has a frame having an infeed portion and an exit portion. A saw is adapted to cut the material, the saw coupled to the frame, an infeed metering conveyor having a position detector is adapted to accept material from the infeed portion and feed the material to the saw. An edge detector is adapted to detect a leading edge of the material when being fed to the saw by the infeed metering conveyor. The position detector and the edge detector cooperate with operation of the saw to meter lengths of material through the infeed metering conveyor and to cut precise lengths of material with the saw. The system is sized to be transportable on the bed of a half ton capacity pick up truck.

In accordance with another exemplary embodiment, an automated stick cutting system is provided adapted to produce stick-frame construction components from material for residential homebuilding. The stick cutting system has a frame having an infeed portion and an exit portion. A saw is adapted to cut the material, the saw coupled to the frame. An infeed metering conveyor has a position detector, the infeed conveyor adapted to accept material from the infeed portion and feed the material to the saw. An exit metering conveyor is adapted to accept uncut material from the infeed conveyor, the exit metering conveyor adapted to accept cut material from the saw. An edge detector is adapted to detect a leading edge of the material when being fed to the saw by the infeed metering conveyor. The position detector and the edge detector cooperate with operation of the saw to meter lengths of material through the infeed metering conveyor and to cut precise lengths of material with the saw.

In accordance with another exemplary embodiment, an automated material cutting system adapted to produce cut construction components from construction material is provided. The material cutting system has a frame having an infeed portion and an exit portion. A saw is adapted to cut the material, the saw having a guide, the saw coupled to the frame. An infeed metering conveyor has a position detector, the infeed conveyor adapted to accept material from the infeed portion and feed the material to the saw. An exit metering conveyor is adapted to accept uncut material from the infeed conveyor, the exit metering conveyor adapted to accept cut material from the saw. An edge detector is adapted to detect a leading edge of the material when being fed to the saw by the infeed metering conveyor. A printer is adapted to print a feature on at least one side of the material. A side clamp is adapted to clamp the material against the guide. The position detector and the edge detector cooperate with operation of the saw to meter lengths of material through the infeed metering conveyor and to cut precise lengths of material with the saw.

It should be understood that the foregoing description is only illustrative of the invention. Various alternatives and modifications can be devised by those skilled in the art without departing from the invention. Accordingly, the present invention is intended to embrace all such alternatives, modifications and variances.

What is claimed is:

1. An automated stick cutting system adapted to produce stick-frame construction components from material for building construction, the automated stick cutting system comprising:
a frame having an in-feed portion and an out-feed portion;
a saw adapted to cut the material, the saw coupled to the frame;
an in-feed drive coupled to the frame, the in-feed drive adapted to accept the material from the in-feed portion and feed the material to the saw;
a position detector coupled to the frame, the position detector adapted to track a position of the material relative to the in-feed drive;
an out-feed drive adapted to accept the material uncut from the in-feed drive, the out-feed drive adapted to accept the material cut from the saw and feed cut material to the out-feed portion; and
an edge detector, the edge detector adapted to detect a leading edge of the material when being fed to the saw by the in-feed drive;
wherein, the position detector and the edge detector cooperate with operation of the saw to meter lengths of the material through the in-feed drive and to cut a predetermined length of the material with the saw; and
wherein the in-feed drive and out-feed drive are both configured for independently positioning the material uncut with respect to the saw.

2. The automated stick cutting system of claim 1 wherein the in-feed drive comprises an in-feed metering conveyor and wherein the out-feed drive comprises an out-feed metering conveyor.

3. The automated stick cutting system of claim 1 further comprising:
a guide coupled to the frame, the guide adapted to guide an edge of the material; and
a side clamp adapted to clamp the material against the guide while the material is being cut by the saw.

4. The automated stick cutting system of claim 1 further comprising a transportable platform, the frame coupled to the transportable platform, wherein the transportable platform is transportable from a first work site to a second work site.

5. The automated stick cutting system of claim 1 further comprising a trailer or a truck, the frame coupled to the trailer or the truck, wherein the trailer or the truck is transportable from a first work site to a second work site.

6. The automated stick cutting system of claim 1 further comprising a printer coupled to the frame, the printer adapted to print a printed feature on at least one side of the material.

7. The automated stick cutting system of claim 1 further comprising a drill coupled to the frame, the drill adapted to drill a drilled feature on at least one side of the material.

8. The automated stick cutting system of claim 1 further comprising a pin setter coupled to the frame, the pin setter adapted to set a pin feature on at least one side of the material.

9. The automated stick cutting system of claim 1 wherein the position detector measures the position of the material independent of a position of the in-feed drive.

10. The automated stick cutting system of claim 1 wherein in-feed portion defines an in-feed opening of an enclosure and wherein the out-feed portion defines an out-feed opening of the enclosure, and wherein the enclosure defines a safety barrier that prevents user access to the saw during a cutting operation of the saw.

11. An automated stick cutting system adapted to produce stick-frame construction components from material for building construction, the automated stick cutting system comprising:
a controller and a frame;
a feed drive coupled to the frame, the feed drive adapted to feed and position the material relative to the frame;
a saw coupled to the frame, the saw adapted to cut a cut feature on the material;
a printer coupled to the frame, the printer adapted to print a printed feature on the material;
a drill coupled to the frame, the drill adapted to drill a drilled feature on the material;
a pin setter coupled to the frame, the pin setter adapted to set a pin feature on the material;
wherein, the controller interfaces with the saw, the feed drive, the printer, the drill and the pin setter to selectively position a set of predetermined features on the material.

12. The automated stick cutting system of claim 11 wherein the feed drive comprises an in-feed metering conveyor and an out-feed metering conveyor.

13. The automated stick cutting system of claim 11 further comprising:
a guide coupled to the frame, the guide adapted to guide an edge of the material; and
a side clamp adapted to clamp the material against the guide while the material is being cut by the saw.

14. The automated stick cutting system of claim 11 further comprising a transportable platform, the frame coupled to the transportable platform, wherein the transportable platform is transportable from a first work site to a second work site.

15. The automated stick cutting system of claim 11 further comprising a trailer or a truck, the frame coupled to the trailer or the truck, wherein the trailer or the truck is transportable from a first work site to a second work site.

16. The automated stick cutting system of claim 11 further comprising a position detector, wherein the position detector measures a position of the material independent of a position of the feed drive.

17. The automated stick cutting system of claim 11 further comprising a position detector and an edge detector, wherein the position detector and the edge detector cooperate with operation of the saw to meter lengths of the material through the feed drive and to cut a predetermined length of the material with the saw.

18. The automated stick cutting system of claim 11, wherein the controller interfaces with a database, the database providing the controller with the set of predetermined features to be applied to the material, the controller adapted to report a status relating to application of the set of predetermined features to the material.

19. A configurable automated stick cutting system adapted to produce stick-frame construction components from material for building construction, the configurable automated stick cutting system comprising:
a controller and a frame;
a feed drive coupled to the frame, the feed drive interfacing with the controller and adapted to feed and position the material relative to the frame; and
a saw coupled to the frame, the saw interfacing with the controller and adapted to cut a cut feature on the material;
the automated stick cutting system having a selectable configuration, wherein the frame has predetermined mounting features configured for selectably mounting at least one component to the frame, the at least one component being selectable for mounting from a group of mountable components each of which having an interface for coupling with the controller, when mounted, for selectively generating a set of predetermined features on the material.

20. The configurable automated stick cutting system of claim 19, wherein the additional components comprise one or more of a printer adapted to print a printed feature on the material; a drill adapted to drill a drilled feature on the material and a pin setter adapted to set a pin feature on the material.

21. The configurable automated stick cutting system of claim 19 wherein the feed drive comprises an in-feed metering conveyor and an out-feed metering conveyor.

22. The configurable automated stick cutting system of claim 19 further comprising:
a guide coupled to the frame, the guide adapted to guide an edge of the material; and
a side clamp adapted to clamp the material against the guide while the material is being cut by the saw.

23. The configurable automated stick cutting system of claim 19 further comprising a transportable platform, the frame coupled to the transportable platform, wherein the transportable platform is transportable from a first work site to a second work site.

24. The configurable automated stick cutting system of claim 19 further comprising a trailer or a truck, the frame coupled to the trailer or the truck, wherein the trailer or the truck is transportable from a first work site to a second work site.

25. The configurable automated stick cutting system of claim 19 further comprising a position detector, wherein the position detector measures a position of the material independent of a position of the feed drive.

26. The configurable automated stick cutting system of claim 19 further comprising a position detector and an edge detector, wherein the position detector and the edge detector cooperate with operation of the saw to meter lengths of the material through the feed drive and to cut a predetermined length of the material with the saw.

27. The automated stick cutting system of claim 19, wherein the controller interfaces with a database, the database providing the controller with the set of predetermined features to be applied to the material, the controller adapted to report a status relating to application of the set of predetermined features to the material.

28. A portable automated stick system adapted to produce stick-frame construction components from material for building construction, the portable automated stick system comprising:
a transportable platform having a pre-cut material staging portion, an automated stick cutting system and a cut material buffering portion all of which are integral to the transport platform;
wherein, the pre-cut material staging portion is configured so that material to be processed in the automated stick cutting system is supported by and staged at the pre-cut material staging portion, wherein the cut material buffering portion is configured so that material that has been processed in the automated stick cutting system is supported by and buffered at the cut material buffering portion, wherein the automated stick cutting system processes the material by applying a set of predetermined features to the material, and wherein the transportable platform is transportable as a unit.

29. The portable automated stick system of claim 28, wherein the automated stick cutting system comprises:
a controller and a frame;
a feed drive coupled to the frame, the feed drive interfacing with the controller and adapted to feed and position the material relative to the frame;
a saw coupled to the frame, the saw interfacing with the controller and adapted to cut a cut feature on the material;
wherein the controller is adapted to selectively position the set of predetermined features on the material.

30. The portable automated stick system of claim 29, wherein the predetermined features comprise one or more of the cut feature, a printed feature a drilled feature and a pin feature.

31. The portable automated stick system of claim 28, wherein the transportable platform is transportable from a first work site to a second work site.

32. The portable automated stick system of claim 28, wherein the transportable platform comprises a trailer or a truck, wherein the trailer or the truck is transportable from a first work site to a second work site.

33. The portable automated stick system of claim 29, wherein the controller interfaces with a database, the database providing the controller with the set of predetermined features to be applied to the material, the controller adapted to report a status relating to application of the set of predetermined features to the material.

34. The portable automated stick system of claim 28 further comprising a panel table, wherein material buffered at the cut material buffering portion is provided to the panel table and assembled into a predetermined panel configuration.

35. The portable automated stick system of claim 34, wherein material buffered at the cut material buffering portion is provided in a predetermined order to the panel table, the predetermined order corresponding to an order in which the material buffered are to be assembled into the predetermined panel configuration.

36. The portable automated stick system of claim 35, wherein the transportable platform comprises first and second trailers, wherein the automated stick cutting system is supported by the first trailer, and wherein the panel table is supported by the second trailer.

37. The portable automated stick system of claim 28, wherein the automated stick cutting system comprises a controller, the controller interfacing with a database, the database providing the controller with the set of predetermined features to be applied to the material, the controller adapted to report a status relating to application of the set of predetermined features to the material.

38. The portable automated stick system of claim 35 further comprising a controller, the controller interfacing with a database, the database providing the controller with the set of predetermined features to be applied to the material, the database providing the controller with the predetermined order corresponding to the order in which the material buffered are to be assembled into the predetermined panel configuration, the controller adapted to report a status relating to application of the set of predetermined features to the material and the assembly of the predetermined panel configuration.
